(19) United States
(12) Patent Application Publication
(10) Pub. No.: US 2003/0182601 A1
(43) Pub. Date: Sep. 25, 2003

(54) System and method for integrating hardware switching operations into test executive software

(76) Inventor: Scott Richardson, Austin, TX (US)

Correspondence Address: Jeffrey C. Hood, Conley, Rose, & Tayon, P.C., P.O. Box 398, Austin, TX, 78767, US

(21) Appl. No.: 10/100,979

(22) Filed: Mar. 19, 2002

(51) Int. Cl. H02H 3/05

(52) U.S. Cl. 714/46

(57) ABSTRACT

A system and method for creating a test executive sequence configured to perform one or more hardware switching operations. A user interface for configuring a first test executive step (i.e., a particular step) in the test executive sequence may be displayed. User input specifying one or more hardware switching operations may be received to the user interface. The first test executive step may be configured to perform the specified one or more hardware switching operations during execution of the test executive sequence. The user interface may enable the user to configure the first test executive step to perform the specified one or more hardware switching operations without requiring user programming or without requiring the user to write source code.

### FIELD OF THE INVENTION

The present invention relates to the field of computer-based test systems. More particularly, the invention relates to the field of test executive software for organizing and executing test executive sequences and to the field of hardware switch devices, wherein the hardware switch devices are useful to connect test instruments to test points on a unit under test.

### DESCRIPTION OF THE RELATED ART

Test executive software is specialized software that allows a user to organize and execute sequences of reusable test modules to test units under test (UUTs). For example, the test modules may interact with one or more hardware instruments to test the UUT(s). The test modules often have a standard interface and typically can be created in a variety of programming environments. The test executive software operates as a control center for the automated test system. More specifically, the test executive software allows the user to create, configure, and/or control test sequence execution for various test applications, such as production and manufacturing test applications. Text executive software typically includes various features, such as test sequencing based on pass/fail results, logging of test results, and report generation, among others.

Test executives include various general concepts. The following comprises a glossary of test executive nomenclature, as used herein:

Code Module—A program module, such as a Windows Dynamic Link Library (.dll), LabVIEW VI (.vi), ActiveX component, or other type of program module or component, that implements one or more functions that perform a specific test or other action.

Test Module—A code module that performs a test of a UUT.

Step—An action that the user can include within a sequence of other actions. A step may call a test module to perform a specific test.

Step Module—The code module that a step calls.

Sequence—A series of steps that the user specifies for execution in a particular order. Whether and when a step is executed can depend on the results of previous steps.

Sequence File—A file that contains the definition of one or more sequences.

Sequence Editor—A program that provides a graphical user interface for creating, editing, and debugging sequences.

Run-time Operator Interface—A program that provides a graphical user interface for executing sequences on a production station. A sequence editor and run-time operator interface can be separate application programs or different aspects of the same program.

Test Executive Engine—A module or set of modules that provide an API for creating, editing, executing, and debugging sequences. A sequence editor or run-time execution operator interface may use the services of a test executive engine.

Application Development Environment (ADE)—A programming environment such as LabVIEW, LabWindows/CVI, Microsoft Visual C++, Microsoft Visual Basic, etc., in which the user can create test modules and run-time operator interfaces.

Unit Under Test (UUT)—The device or component that is being tested.

Thus, the user may use the sequence editor to construct a test executive sequence comprising a plurality of steps. The test executive sequence may then be executed to perform tests of a system or UUT.

Many test and measurement systems utilize hardware switch devices to switch between different data sources and data sinks, e.g., between different sensors and instruments. A switch device is an instrument that can establish connections between I/O channels, e.g., by opening and closing circuits. Switch devices are an important part of many test and measurement systems because they can be used to connect multiple test points to multiple instruments, e.g., to test or acquire data from a unit under test. Switch devices come in a variety of types and sizes to meet a wide range of computer-based testing and measurement needs. Switch devices can be differentiated by their mechanical characteristics and topology and may include any of various kinds of switches.

During execution of a test executive sequence, it is often necessary to interact with one or more switch devices, e.g., to configure the switching system in such a way that steps in the sequence execute properly to test the unit under test (UUT).

### SUMMARY

One embodiment of the present invention comprises a system and method for creating a test executive sequence configured to perform one or more hardware switching operations. A plurality of test executive steps may be included in the test executive sequence, e.g., in response to user input. A user interface for configuring a first test executive step (i.e., a particular step) in the test executive sequence may be displayed, wherein the user interface displays information regarding one or more hardware switching operations. User input may be received to the user interface, wherein the user input specifies one or more hardware switching operations to perform. The user interface may display information enabling the user to specify the one or more hardware switching operations to perform without requiring user programming or without requiring the user to write source code.

In various embodiments, the user interface may enable the user to specify any of various kinds of hardware switching operations. Exemplary hardware switching operations are described below. In one embodiment, in specifying a hardware switching operation, the user may specify a portion of previously stored switch configuration information. As one example, if the switch configuration information includes preconfigured routes, and the user desires the first test executive step to connect and/or disconnect one or more of the routes, the user may specify the desired route names to connect and/or disconnect.

The first test executive step may then be configured to perform the specified one or more hardware switching operations. For example, the step may be configured to invoke program instructions during execution of the test executive sequence that will cause the specified one or more hardware switching operations to be performed. Information representing the test executive sequence may be stored. For example, the test executive sequence may be represented using one or more data structures stored on a memory medium.

After the test executive sequence has been created, the sequence may be executed. Executing the test executive sequence may include executing the first test executive step. Executing the first test executive step may include performing the specified one or more hardware switching operations. For example, the hardware switching operations may affect the configuration of one or more switch devices to facilitate the testing of a UUT as the test executive sequence executes.

As noted above, in various embodiments the first test executive step may be configured to perform various kinds of hardware switching operations. In one embodiment, the step may be configured to perform a connect operation to cause connections to be made in one or more switch devices, and/or the step may be configured to perform a disconnect operation to cause disconnections to be made in one or more switch devices. For example, the user may specify one or more routes to connect and/or disconnect. For example, in specifying the one or more routes, the user may specify one or more of: one or more route names, wherein each route name references a pre-configured route; one or more route groups, wherein each route group references a plurality of pre-configured routes; and/or a fully specified path between a source channel and a destination channel.

In addition to connect and disconnect operations, the first test executive step may be configured to perform various other kinds of hardware switching operations. Exemplary hardware switching operations include: determining connectivity between channels in one or more switch devices; querying one or more switch devices for information; causing one or more switch devices to perform a scanning operation; perform a wait operation, wherein the wait operation comprises waiting for one or more switches to debounce; configuring one or more switches in one or more switch devices; sending a software trigger command to one or more switch devices; etc.

In an embodiment in which the test executive software supports step types, the test executive software may implement a switch step type. In this case, the first test executive step may be an instance of a switch step type. The switch step type may be a specialized step type for performing hardware switching operations. One embodiment of a switch step type is described in detail.

In another embodiment, the test executive software may not support the use of step types, or the first test executive step may be an instance of a type other than a specialized switch step type. However, the user may still be able to configure the step to perform one or more hardware switching operations. For example, each step in the test executive sequence may have an associated user interface for configuring general properties of the respective step. This user interface may enable the user to specify properties of the step related to hardware switching operations, e.g., may enable the user to configure the step to perform one or more hardware switching operations. Thus, the user may be able to configure the step to perform one or more hardware switching operations regardless of the type of step.

Where the first test executive step is configured to call a code module, the user may utilize the user interface to specify one or more hardware operations to be performed before and/or after execution of the code module. For example, the user may specify a connect and/or disconnect operation to be performed before and/or after the respective code module executes during execution of the test executive sequence. As one example, the user may specify a connect operation to be performed before the code module executes and a disconnect operation to be performed after the code module executes.

### BRIEF DESCRIPTION OF THE DRAWINGS

A better understanding of the present invention can be obtained when the following detailed description of the preferred embodiment is considered in conjunction with the following drawings, in which:

FIG. 1 is a diagram illustrating an exemplary embodiment of a test system which includes a switching system;

FIG. 2 illustrates an exemplary embodiment of a test system similar to the test system of FIG. 1, also illustrating a computer system;

FIG. 3 illustrates various types of instruments that may be coupled to the computer system and included in an instrument system in various embodiments;

FIG. 4 is a block diagram illustrating an embodiment in which the computer system maintains a virtual switch device;

FIG. 5 is a block diagram representing one embodiment of the computer system illustrated in FIGS. 2-4;

FIG. 6 is a block diagram illustrating high-level architectural relationships between elements of one embodiment of a test executive software application;

FIG. 7 illustrates one example of a test executive sequence, created according to one embodiment of a test executive application;

FIG. 8 illustrates an user interface for a test executive step, which enables the user to specify various properties for the step that affect the way the test executive software manages the execution of the step;

FIG. 9 is a flowchart diagram illustrating one embodiment of a method for testing a unit under test (UUT) using computer-based testing system that includes one or more switch devices;

FIG. 10 is a flowchart diagram illustrating one embodiment of a method for creating a test executive sequence configured to perform one or more hardware switching operations;

FIGS. 11-22 illustrates exemplary user interfaces related to one embodiment of a switch step type, wherein the user interfaces enable a user to configure an instance of the switch step type to perform various hardware switching operations; and

FIG. 23 illustrates an exemplary user interface for configuring a step to perform a hardware switching operation, where the step is not an instance of a switch step type.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Incorporation by Reference

The following references are hereby incorporated by reference in their entirety as though fully and completely set forth herein.

U.S. patent application Ser. No. 09/259,162 titled “Test Executive System and Method Including Step Types for Improved Configurability,” filed Feb. 26, 1999.

U.S. Provisional Patent Application No. 60/312,547 titled “Switch Executive,” filed Aug. 15, 2001.

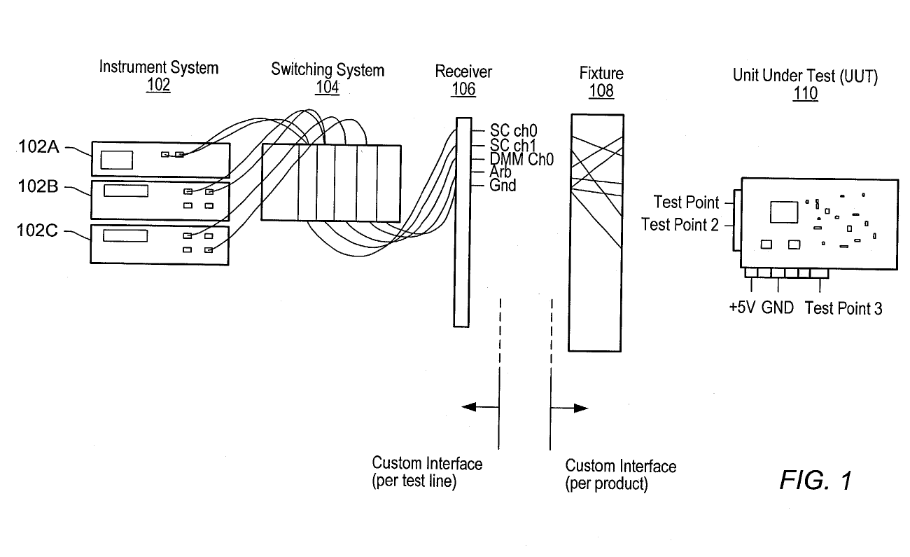

FIG. 1—Exemplary Test System

FIG. 1 is a diagram illustrating an exemplary embodiment of a test system which includes a switching system 104. The test system may be utilized when executing a test executive sequence to test a unit under test (UUT) 110. FIG. 1 illustrates an instrument system 102 that includes comprising one or more devices or instruments 102A, 102B and 102C, which couple through the switching system 104 to a receiver 106. The receiver 106 may in turn couple to a fixture 108, which then connects to a plurality of test points on a device under test (DUT) 110, also referred to as a unit under test (UUT) 110. The test system may be utilized when executing a test executive sequence to test the UUT 110. For example, the switching system 104 may be operable to connect/disconnect channels of the instrument system 102 and test points of the UUT 110 during execution of the test executive sequence. As another example, when multiple UUTs 110 are being tested together, the switching system 104 may be operable to change which UUT 110 the instrument system 102 is connected to, e.g., so that each UUT 110 is tested.

The instrument system 102 may include any of various kinds of instruments or devices, including oscilloscopes, multimeters, computer-based instruments, signal generation devices and various other types of instruments or measurement devices, as well as power supplies, among others. The instrument(s) 102A, 102B, 102C may have various form factors. For example, the instrument(s) 102 may include a computer coupled to a GPIB instrument over a GPIB or IEEE 488 bus. Alternatively, the instrument system 102 may include a PXI chassis including a PXI controller and one or more PXI instruments, a computer system coupled to a PXI chassis which includes one or more PXI instruments, a computer system which includes a computer-based instrument card, such as an oscilloscope or multimeter card, such as those available from National Instruments Corporation, a VXI chassis including one or more VXI instruments, a system including a data acquisition card, or a traditional standalone instrument such as those available from Agilent, Tektronix, Keithley and others. The instrument system 102 may also include an image acquisition or machine vision system, such as a computer system including a video capture or image processing board, or a motion control device. Further, the instrument(s) 102 may include various types of industrial automation, control devices, or other devices, such as a programmable logic device (PLD), programmable logic controller (PLC), a distributed I/O system such as FieldPoint available from National Instruments Corporation, or other type of device. In general, the instrument system or measurement system 102 may include any of various kinds of devices operable to acquire or generate signals.

The switching system 104 may comprise one or more switch devices. A switch device may include switches of various types, including general-purpose switches, multiplexers, and matrix switches among others. In a typical configuration, the switching system 104 may include a rack or chassis adapted to receive one or more switch cards. One example of a switching system is the SCXI (Signal Conditioning eXtensions for Instrumentation) System available from National Instruments Corporation. An SCXI chassis may contain one or more switch devices as well as other types of signal conditioning cards such as for isolation filtering etc. The switching system 104 may include switch devices from various different vendors as well. As discussed below, in one embodiment, a computer system 101 may be operable to configure two or more switch devices, possibly from different vendors, as a single virtual switch device 105, thus simplifying operation of the switching system 104 to the user.

As shown, the various switch devices in the switching system 104 may couple to the instrument through various wires or cables. Another common switching system configuration is a rack-mounted system wherein the switch devices are arranged vertically with various wires or cables connecting the switch devices together.

The various switch devices in the switching system 104 may also include one or more hardwire connections. A hardwire connection may include a connection made using a physical wire segment between a first channel on a first switch device and a second channel on a second switch device. This may facilitate use of the multiple switch devices as a single virtual switch device 105. For example, the user may utilize a route editor to pre-configure a route utilizing channels of both the first switch device and the second switch device, wherein a hardwire connection connects the first switch device to the second switch device.

The receiver 106 may couple to the various switch devices in the switching system 104 through various wires or cables as shown. The receiver 106 may couple to the fixture 108. The fixture 108 may separate out the signal lines and couple the signal lines to the unit under test 110. As shown, the receiver 106 may provide a custom interface for each signal line. The fixture 108 may provide a custom interface on a per product basis. The receiver 106 and the fixture 108 may simplify the task of creating and dismantling measurement and test systems coupled to various devices or units under test 110.

The unit under test (UUT) 110, also called a device under test (DUT) 110, may be one of any of various elements or devices that are desired to be tested. In one embodiment, one or more various types of sensors may be coupled to the UUT 110 to transduce a physical phenomena generated by the UUT into electrical signals for providing through the fixture 108 and receiver 106 and through the switching system 104 to the instrument system 102. Examples of various sensors or transducers include thermisters, temperature sensors, pressure sensors, microphones, RTDs, strain gauges, etc. The UUT 110 may be operable to generate signals to the instrument system 102, i.e., may generate phenomena that are transduced into signals for receipt by the instrument system 102. Also, the instrument system 102 may include an arbitrary waveform generator or other signal generation capability to stimulate or control the UUT 110. Thus, the switching system 104 may act as a conduit for two-way communication between the instrument system 102 and the UUT 110.

It is noted that any of various test system architectures may include a switching system, and the switching system itself may vary in various ways. In other words, FIG. 1 is intended to be exemplary only.

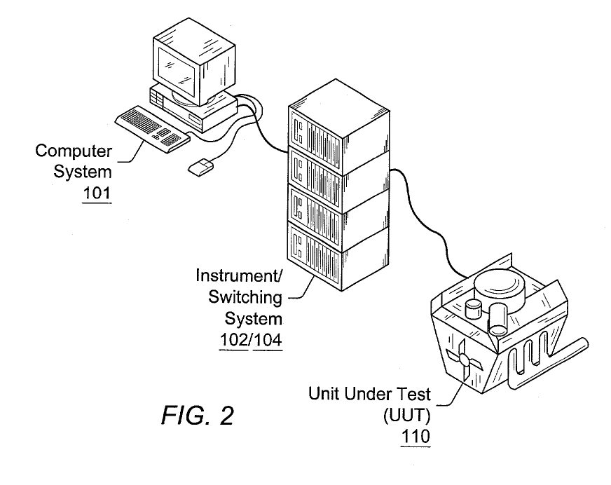

FIG. 2—Test System Including Computer System

FIG. 2 illustrates an exemplary embodiment of a test system such as described above with reference to FIG. 1, wherein the test system includes a computer system 101. The computer system 101 is coupled to the instrument system 102. The instrument system 102 is coupled to the switching system 104, which in turn couples to the UUT 110. The instrument system 102 and the switching system 104 are shown together in the example of FIG. 2, e.g., mounted in a single rack, and are referred to below as the instrument/switching system 102/104. As shown, the computer 101 may include a separate computer system coupled to the instrument/switching system 102/104. The instrument/switching system 104 may include various chassis, such as various PXI and/or SCXI chassis. One or more measurement devices or instruments 102A, 102B, 102C may be included in the computer system 101 or in the instrument system 102.

The computer system 101 may include a memory, which may store test executive software according to one embodiment of the invention. The test executive software may be operable to manage execution of a test executive sequence, wherein the test executive sequence may be configured to perform one or more hardware switching operations, as described below. For example, a hardware switching operation may include an operation that controls or affects one or more switch devices in the switching system 104. The operation of the test executive software is discussed in greater detail below.

In one embodiment, the memory may also store a program referred to herein as a switch executive program that can be used to create and/or store switch configuration information. For example, the switch executive program may allow the user to set up the switching system using a configuration tool. The configuration tool may allow the user to store switch configuration information, wherein the switch configuration information may include any of various kinds of information relating to the switching system 104. For example, the switch configuration information may include information such as which switch devices make up the switching system (e.g., by defining a virtual device 105 that includes one or more actual switch devices), alias names assigned to channels/pins, defined hardwire connections, pre-configured routes and route groups, etc. In one embodiment, the switch configuration information may facilitate configuring a test executive sequence to perform one or more hardware switching operations.

The computer system 101 may also store various switch device drivers that include information regarding the various switch devices that they control. In one embodiment, one or more of the switch devices may be IVI-compliant switch devices, and various IVI switch device drivers included in the computer system may be operable to publish information regarding capabilities of the IVI-compliant switch devices that they control.

In another embodiment, the computer system 101 may be implemented as a card included in one of the chassis of the instrument/switching system 102/104. For example, the rack shown in FIG. 2 may include one or more PXI chassis and one or more SCXI chassis. The computer system may optionally be implemented as a PXI card contained in a PXI chassis of the rack. A monitor or display device, as well as various I/O devices such as a mouse or keyboard, may connect to the card in order to provide a user interface to aid the user in using the computer system.

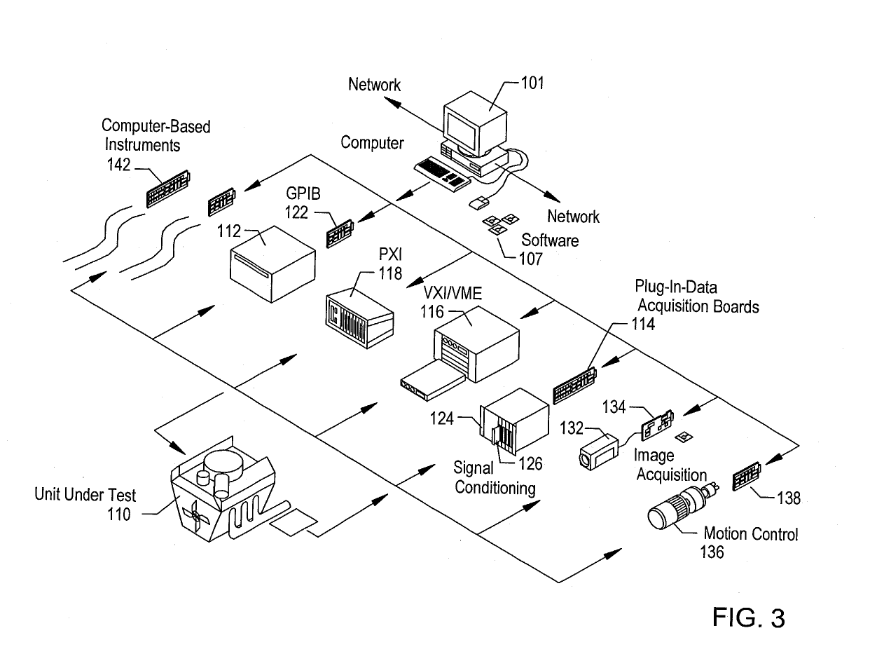

FIG. 3—Instrumentation System

FIG. 3 illustrates various types of instruments that may be coupled to the computer system 101 and included in the instrument system 102 in various embodiments. The host computer 101 may comprise a CPU, a display screen, memory, and one or more input devices such as a mouse or keyboard as shown. The computer 101 may execute a test executive sequence operable to analyze, measure, and/or control a unit under test (UUT) or process 110. For example, the test executive sequence may include various steps referencing code modules operable to connect through the one or more instruments to analyze, measure, or control the unit under test (UUT) or process 110. As described above, the switching system 104 (not shown in FIG. 3) may facilitate connection between the instruments and the UUT. It is noted that FIG. 3 is exemplary only, and the present invention may be used in conjunction with any of various systems, as desired.

The one or more instruments may include a GPIB instrument 112 and associated GPIB interface card 122, a data acquisition board 114 and associated signal conditioning circuitry 124, a VXI instrument 116, a PXI instrument 118, a video device 132 and associated image acquisition card 134, a motion control device 136 and associated motion control interface card 138, and/or one or more computer based instrument cards 142, among other types of devices.

The GPIB instrument 112 may be coupled to the computer 101 via a GPIB interface card 122 provided by the computer 101. In a similar manner, the video device 132 may be coupled to the computer 101 via the image acquisition card 134, and the motion control device 136 may be coupled to the computer 101 through the motion control interface card 138. The data acquisition board 114 may be coupled to the computer 101, and optionally interfaces through signal conditioning circuitry 124 to the UUT. The signal conditioning circuitry 124 preferably comprises an SCXI (Signal Conditioning eXtensions for Instrumentation) chassis comprising one or more SCXI modules 126.

The GPIB card 122, the image acquisition card 134, the motion control interface card 138, and the DAQ card 114 are typically plugged in to an I/O slot in the computer 101, such as a PCI bus slot, a PC Card slot, or an ISA, EISA or MicroChannel bus slot provided by the computer 101. However, these cards 122, 134, 138 and 114 are shown external to computer 101 for illustrative purposes. The cards 122, 134, 138 and 114 may also be implemented as external devices coupled to the computer 101, such as through a serial bus.

The VXI chassis or instrument 116 may be coupled to the computer 101 via a serial bus, MXI bus, or other serial or parallel bus provided by the computer 101. The computer 101 preferably includes VXI interface logic, such as a VXI, MXI or GPIB interface card (not shown), which interfaces to the VXI chassis 116. The PXI chassis or instrument is preferably coupled to the computer 101 through the computer's PCI bus.

A serial instrument (not shown) may also be coupled to the computer 101 through a serial port, such as an RS-232 port, USB (Universal Serial bus) or IEEE 1394 or 1394.2 bus, provided by the computer 101. In typical systems an instrument will not be present of each interface type, and in fact many systems may only have one or more instruments of a single interface type, such as only GPIB instruments. Other types of instruments or devices may be connected to the system, as desired.

The term “memory medium” is intended to include an installation medium, e.g., a CD-ROM, floppy disks 107, or tape device; a computer system memory or random access memory such as DRAM, SRAM, EDO RAM, Rambus RAM, etc.; or a nonvolatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The host computer CPU executing code and data from the memory medium may comprise a means for implementing the methods described below.

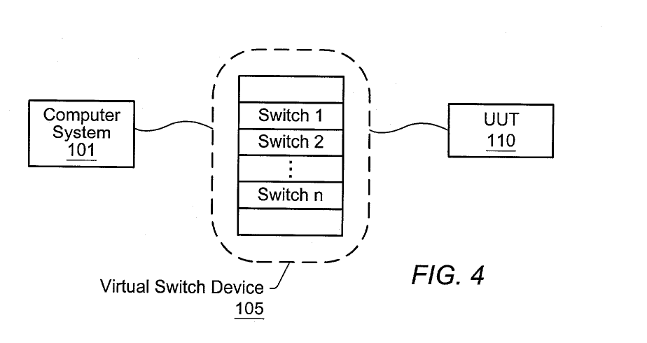

FIG. 4—Virtual Switch Device

FIG. 4 is a block diagram illustrating an embodiment in which the computer system 101 maintains a virtual switch device 105. The virtual switch device 105 may include a software entity or a software object which represents one or more of the switch devices in the switching system 104. The term “virtual switch device” may also refer to two or more hardware switch devices that operate as a single virtual switch device. The user may select one or more of the physical switch devices for inclusion in the virtual switch device 105. In the example shown in FIG. 4, the virtual switch device 105 encompasses software for n switch devices, referred to as switch 1, switch 2, . . . switch n. The switch devices in the virtual switch device 105 software object may couple to the UUT 110.

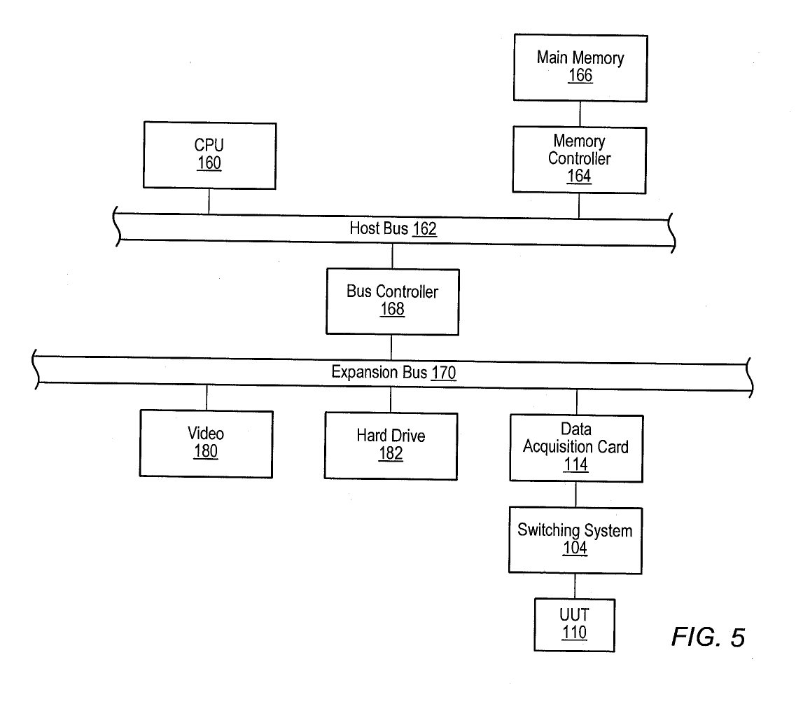

FIG. 5—Computer System Block Diagram

FIG. 5 is a block diagram representing one embodiment of the computer system 101 illustrated in FIGS. 2-4. It is noted that any type of computer system configuration or architecture can be used as desired, and FIG. 5 illustrates a representative PC embodiment. It is also noted that the computer system may be a general purpose computer system, a computer implemented on a VXI card installed in a VXI chassis, a computer implemented on a PXI card installed in a PXI chassis, or other types of embodiments. Elements of a computer not necessary to understand the present description have been omitted for simplicity.

The computer may include at least one central processing unit or CPU 160 which is coupled to a processor or host bus 162. The CPU 160 may be any of various types, including an x86 processor, e.g., a Pentium class, a PowerPC processor, a CPU from the SPARC family of RISC processors, as well as others. Main memory 166 may be coupled to the host bus 162 by means of memory controller 164. The main memory 166 may store test executive software such as described herein and/or a test executive sequence created using such software, wherein the test executive sequence is configured to perform one or more hardware switching operations. The main memory 166 may also store switch executive software such as described herein. The main memory 166 may also store switch device drivers for communicating with switch devices. The main memory 166 may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as a data acquisition board 114. The computer system 101 further comprises a video display subsystem 180 and a hard drive 182 coupled to the expansion bus 170.

In the embodiment shown in FIG. 5, the instrument system 102 includes a data acquisition (DAQ) card 114. The DAQ card 114 may couple to a switching system 104, such as an SCXI chassis that includes one or more switch devices. These one or more switch devices may in turn couple to a UUT 110. As noted above, various other embodiments are contemplated, such as a PXI system which includes a PXI instrument card in one or more PXI switch devices, a VXI system which includes a VXI system instrument card in one or more VXI switch devices, and other form factors, including distributed I/O systems such as FieldPoint available from National Instruments.

Test Executive Software Components

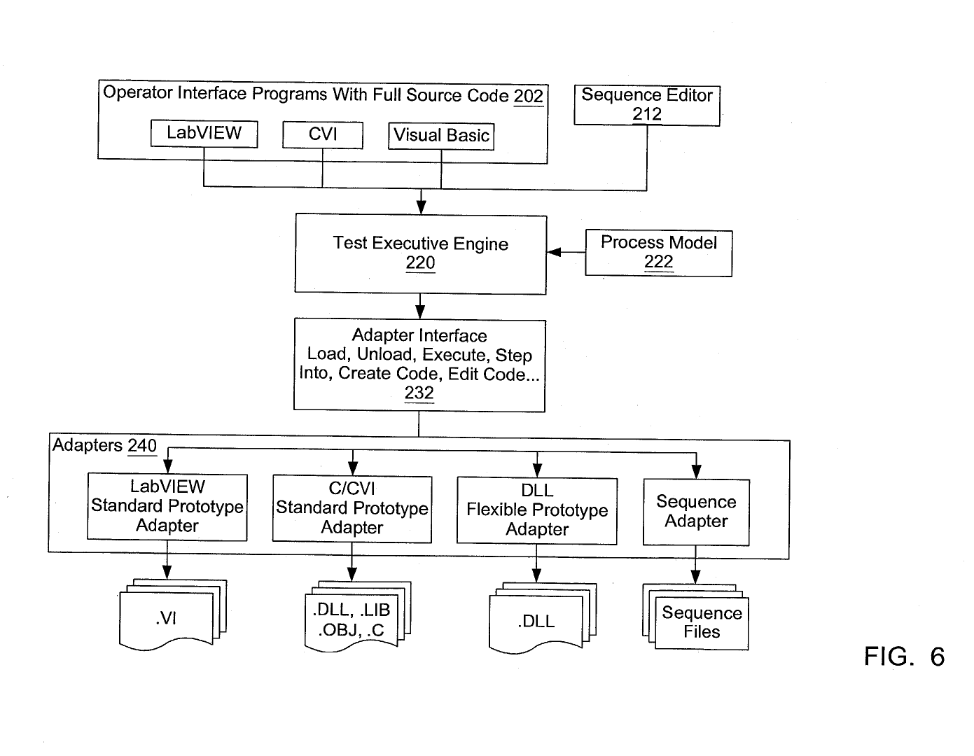

FIG. 6 is a block diagram illustrating high-level architectural relationships between elements of one embodiment of a test executive software application. It is noted that FIG. 6 is exemplary, and the present invention may be utilized in conjunction with any of various test executive software applications or architectures. In one embodiment, the elements of FIG. 6 are included in the TestStand test executive product from National Instruments. As shown, the test executive software of FIG. 6 includes operator interface programs 202 for interfacing to various software programs. The operator interface programs 202 shown in FIG. 6 are for creating operator interface programs using the LabVIEW, LabWindows/CVI, and Visual Basic application development environments. However, additional operator interface programs 202 may be included for development with other application development environments.

The test executive software of FIG. 6 also includes a sequence editor 212 for creating and editing test executive sequences. The sequence editor 212 and the operator interface programs 202 interface to the test executive engine 220. One or more process models 222 couple to the test executive engine 220. The test executive engine 220 interfaces through an adapter interface 232 to one or more adapters 240. The adapters shown in FIG. 6 include the LabVIEW standard prototype adapter, the C/CVI prototype adapter, the DLL flexible prototype adapter, and the sequence adapter. The LabVIEW standard prototype adapter interfaces to program modules having a VI extension, i.e., LabVIEW graphical programs. The C/CVI prototype adapter interfaces to program modules having a .dll, lib, .obj, or .c extension. The DLL flexible prototype adapter interfaces to program modules having a .dll extension. The sequence adapter interfaces to sequence files.

The test executive engine 220 manages the execution of test executive sequences. Test executive sequences include test executive steps that may call external or usersupplied code modules. By using module adapters 240 that have the standard adapter interface 232, the test executive engine 220 can load and execute different types of code modules. Thus, the test executive may be independent from particular application development environments (ADEs) used to create the code modules. In one embodiment, the test executive may use a special type of sequence called a process model to direct the high-level sequence flow. The test executive engine 220 may implement an API used by the sequence editor 212 and run-time operator interfaces 202.

Test Executive Sequence Editor

The sequence editor 212 may be an application program in which the user creates, modifies, and/or debugs test executive sequences. The sequence editor 212 may have a graphical user interface (GUI) enabling a user to efficiently create a test executive sequence for testing a system or unit under test. For example, the sequence editor 212 may provide the user with easy access to test executive features, such as step types, step properties, sequence parameters, step result collection, etc.

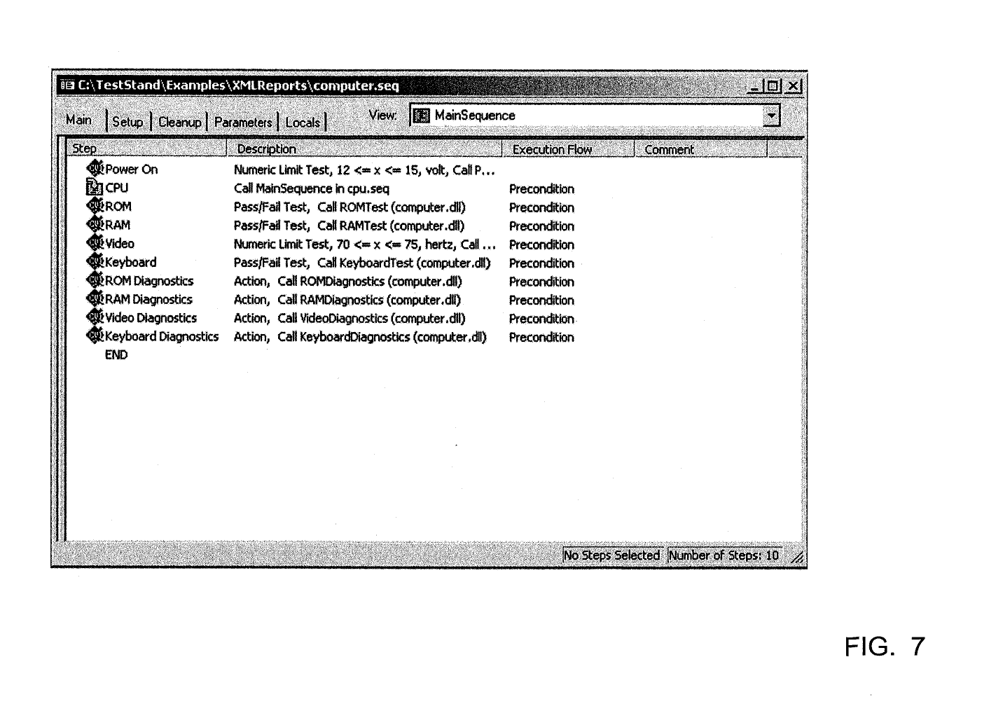

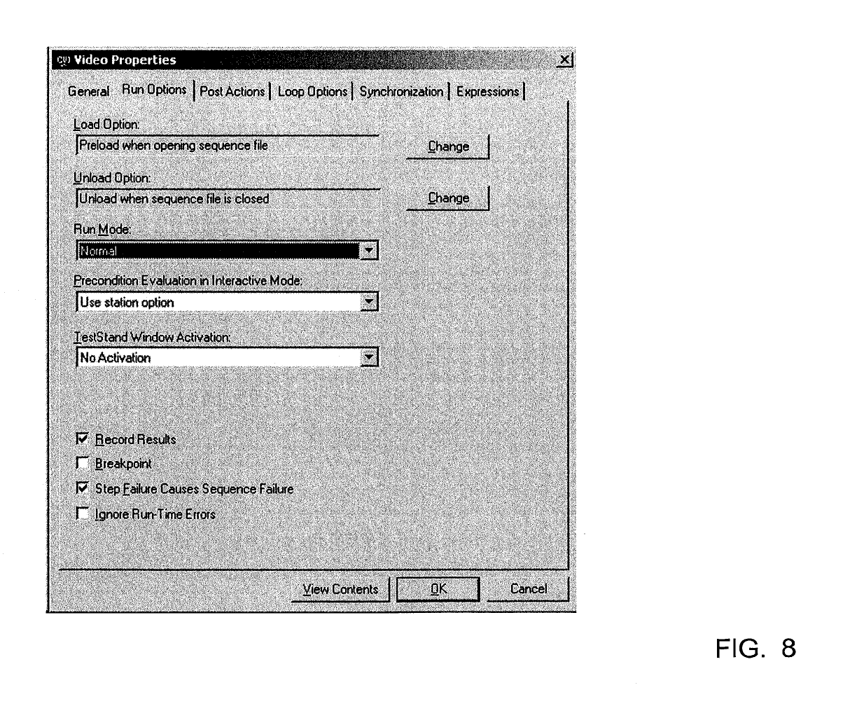

FIG. 7 illustrates one example of a test executive sequence, created according to one embodiment of a sequence editor 212. The exemplary sequence of FIG. 7 comprises a plurality of test executive steps operable to test various aspects of a computer system. For example, the sequence includes a “ROM” step to test the computer's read-only memory, a “RAM” step to test the computer's random access memory, etc. Each step may call a user-supplied code module that interacts with the computer system to perform the desired test. The user may also specify various properties for each step that affect the way the test executive software manages the execution of the step. For example, FIG. 8 illustrates an exemplary dialog box for the “Video” step. As shown, a “Run Options” property page is selected in FIG. 8. The “Run Options” property page enables the user to specify various options for the step, such as whether to collect test results for the step, whether to break execution when the step is reached, whether to preload the step when opening the sequence file, etc.

In one embodiment, the sequence editor 212 may also include an execution window that provides debugging tools, e.g., those found in application development environments such as LabVIEW, LabWindows/CVI, Microsoft Visual C/C++, Microsoft Visual Basic, etc. These may include features such as breakpoints, single stepping, tracing, a variable display, and a watch window.

Test Executive Engine

The test executive engine 220 may be used when creating, editing, executing, and debugging test executive sequences. The test executive engine 220 may also provide a test executive engine application programming interface (API) that enables another program to interface with the test executive engine 220 in order to perform these actions. In one embodiment, the test executive engine 220 may export an object-based or component-based API, which in one embodiment may be an ActiveX Automation API. The sequence editor 212 and run-time operator interfaces 202 may use the test executive engine API. The engine API may be called from any programming environment able to use the API. For example, where the API comprises an ActiveX Automation API, the engine API may be called from any programming environment that supports access to ActiveX Automation servers. Thus, in various embodiments, the engine API may be called from test modules written in various programming environments, including test modules that are written in LabVIEW, LabWindows/CVI, Microsoft Visual C++, Microsoft Visual Basic, Java, etc.

One task performed by the test executive engine 220 is to manage the execution of test executive sequences. Executing a sequence may comprise executing steps included in the sequence. Not all steps in the sequence are necessarily executed. For example, the user may configure some steps to be skipped, e.g., depending on execution results of previous steps.

For a step that references a user-supplied code module, executing the step may comprise executing the respective code module. In addition to these user-supplied code modules being executed, for each step, additional program instructions may be executed, wherein these additional program instructions implement additional functionality specified for the step. These additional program instructions may be specified by the test executive software, rather than being defined by the respective user-supplied code module for the step.

As one example, when including a step in a sequence, the user may utilize a user interface provided by the test executive software to configure the step to perform one or more hardware switching operations. For example, the user interface may enable the user to specify one or more routes or paths to connect and/or disconnect before and/or after execution of the respective code module. In this example, when the step is executed, program instructions to perform the specified hardware switching operation(s) may be executed in addition to the program instructions of the code module that the step references. Thus, the user may be able to configure the step to perform the hardware switching operation(s) at a high level, e.g., by interacting with a graphical user interface, without requiring the user to write or reference source code that implements the hardware switching operation(s).

It is noted that not all steps may reference a user-supplied code module. For example, the test executive may provide some step types that primarily affect various aspects of sequence execution and are not designed to reference user-supplied code modules. These steps may also be configured to perform one or more hardware switching operations.

As a test executive sequence is executed, various results may be generated, and these results may be collected, e.g., may be stored in one or more data structures. In various embodiments, the results may be generated or structured in any of various ways. For example, in one embodiment, there may be one or more results for the unit under test (UUT) as a whole, as well as results for individual steps in the sequence. The results may vary in data type as well.

Variables and Properties

In one embodiment, the test executive system may support the use of variables and/or properties. As used herein, variables and properties may include locations in which data can be stored. Each step in a test executive sequence may have properties. For example, a step might have an integer error code property. The type of a step may determine the set of properties which are included in the step. Step types are discussed below.

Values that are stored in variables and properties can be passed to code modules. The test executive API may be useable to access variable and property values directly from code modules. For example, when executing sequences, the test executive may maintain a “sequence context” that contains references to variables and step properties in active sequences. The contents of the sequence context may change depending on the currently executing sequence and step. If the user passes a sequence context object reference to the code module, the test executive API can be used to access the variables and properties in the sequence context.

The values of variables and properties can be used in numerous ways, such as using a property value to determine whether to execute a step. Sometimes the user desires to use an “expression”, which is a formula that calculates a new value from the values of multiple variables or properties. An expression may be used anywhere a simple variable or property value is used. In expressions, the user can access all variables and properties in the sequence context that is active when the expression is evaluated. The following is an example of an expression:

Locals.MidBandFrequency=(Step.HighFrequency+Step.LowFrequency)/2

The test executive may support applicable expression operators and syntax that are used in programming languages such as C, C++, Java, Visual Basic, etc.

Categories of Properties

As described above, a property may include a container of information. A property can contain a single value, an array of values of the same type, or no value at all. A property can also contain any number of sub-properties. Each property may have a name. A value may have a data type, such as a Number, a String, a Boolean, etc. In one embodiment, the following categories of properties may be supported:

A “single-valued” property contains a single value, such as a Number, String, or Boolean value, etc.

An “array” property contains an array of values. There may be Number Array properties, String Array properties, Boolean Array properties, etc.

A “property-array” property contains a value that is an array of sub-properties. In addition to the array of sub-properties, property-array properties can contain any number of sub-properties of other types.

An “object” property contains no values. Typically, object properties contain multiple sub-properties. Object properties are analogous to structures in C/C++ and to clusters in LabVIEW.

Standard and Custom Named Data Types

In one embodiment, when the user creates a variable or property, the user may specify its data type. In some cases, a simple data type such as a Number or a Boolean is used. In other cases, the user can define his/her own data type, by creating a named data type, in which sub-properties are added to create an arbitrarily complex data structure. When a named data type is created, the user can reuse the named data type for multiple variables or properties. Although each variable or property that the user creates with a named data type has the same data structure, the values they contain can differ.

The test executive may define certain standard named data types, such as Path, Error, and CommonResults.

The user can define his/her own custom named data types. The user must choose a unique name for each of the custom data types. Sub-properties in each custom data type can be added or deleted without restriction. For example, the user might create a “Transmitter” data type that contains sub-properties such as “NumChannels” and “Power Level”.

When the user creates a variable or property, the user can select from among the simple property types and the named data types.

Built-In and Custom Properties

In one embodiment, the test executive may define various properties that are always present for objects such as steps and sequences. An example is a step “run mode” property. Such properties are referred to as built-in properties. The user can define new properties in addition to the built-in properties. Examples are high and low limit properties in a step or local variables in a sequence. Such properties are referred to as custom properties.

Steps

As described above, a test executive sequence comprises a plurality of steps. A step can do many things, such as initializing an instrument, performing a complex test, or making a decision that affects the flow of execution in a sequence. Steps can perform these actions through several types of mechanisms, including jumping to another step, executing an expression, calling a sub-sequence or calling an external code module. The term “step module” is used to refer to the code module that a step calls.

Steps may have custom properties. For steps that call code modules, custom step properties may be useful for storing parameters to pass to the code module for the step. They may also serve as a place for the code module to store its results. The test executive API may be used to access the values of custom step properties from code modules.

In one embodiment, not all steps call code modules. Some steps may perform standard actions that the user configures using a dialog box. In this case, custom step properties may be useful for storing the configuration settings that the user specifies.

Built-In Step Properties

Steps may have a number of built-in properties that the user can specify. In one embodiment, exemplary built-in step properties include:

Preconditions that allow the user to specify the conditions that must be true for the test executive to execute the step during the normal flow of execution in a sequence.

Load/Unload Options that allow the user to specify when the test executive loads and unloads the code modules or subsequences that each step invokes.

Run Mode that allows a step to be skipped or forced to pass or fail without executing the step module.

Record Results that allows the user to specify whether the test executive collects the results of the step.

Step Failure Causes Sequence Failure that allows the user to specify whether the test executive sets the status of the sequence to “Failed” when the status of the step is “Failed”.

Ignore Run-Time Errors that allows the user to specify whether the test executive continues execution normally after the step even though a run-time error occurs in the step.

Post Actions that allows the user to specify the execution of callbacks or jump to other steps after executing the step, depending on the pass/fail status of the step or any custom condition.

Loop options that allow the user to cause a single step to execute multiple times before executing the next step. The user can specify the conditions under which to terminate the loop. The user can also specify whether to collect results for each loop iteration, for the loop as a whole, or for both.

Pre Expression that allows the user to specify an expression to evaluate before executing the step module.

Post Expression that allows the user to specify an expression to evaluate after executing the step module.

Status Expression that allows the user to specify an expression to use to set the value of a “status” property of the step automatically.

Step Types

In one embodiment, the test executive system may support the use of “step types”. In a test executive sequence having a number of steps, in many instances the user will desire a number of steps that have some commonality of functionality and/or properties. Thus, a step type may be implemented to define common properties and/or operations associated with a plurality of steps, thereby eliminating the need for the user to define these common properties and/or operations for each of the respective steps. Step instances of the step type incorporate this common finctionality and/or properties from the step type, and thus the user is not required to hard code that functionality and/or properties in each instance or step.

In one embodiment, step types may define common functionality by defining pre and post sub-steps. When a first step in a test executive sequence of a given step type is executed, the pre and post sub-steps may execute before and after, respectively, the first step. Step types may also include pre and post expressions and status expressions for configurability, which may be executed at runtime.

A step type may have similar functionality to a type definition, in that once the user has configured a step type and created steps of that step type in a sequence, if the user later changes that step type, those changes may propagate through all of the steps which are based on that step type. In one embodiment, this functionality is not performed by copying or propagating changes. Rather, the information may be held within the step type, and during runtime the sequence may examine the step type to determine proper execution of a step of that step type.

As one example of a step type, a “Numeric Limit Test” step type may be defined. Steps of this step type may call a code module that returns a single measurement value. After the code module executes, the Numeric Limit Test step type may compare the measurement value to specified limits. If the measurement value is within the bounds of the limits, the step type may set a status value for the step to “Passed”. Otherwise, the status value may be set to “Failed”.

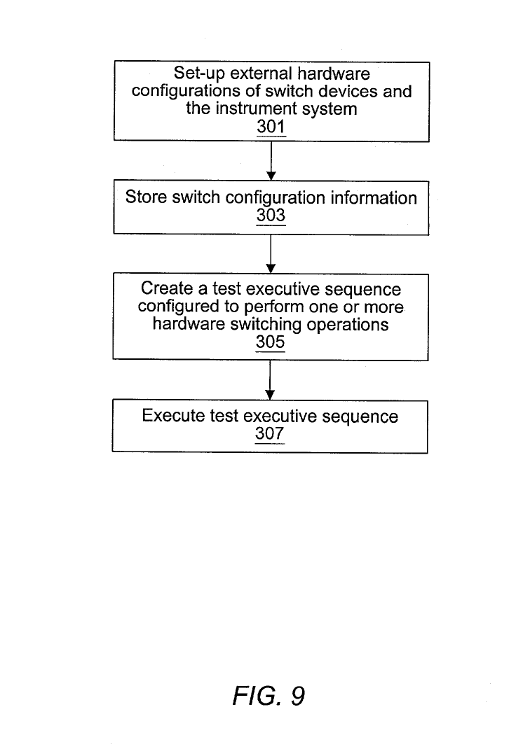

FIG. 9—Testing a Unit Under Test

FIG. 9 is a flowchart diagram illustrating one embodiment of a method for testing a unit under test (UUT) using computer-based testing system that includes one or more switch devices.

In step 301, the user may set up the hardware for the switching system 104 and/or the instrument system 102. For example, setting up the instrument system 102 may include coupling one or more instruments, e.g., 102A, 102B, 102C, to a computer system 101, e.g., as a card comprised in the computer system 101 or in a separate chassis or a separate standalone instrument. The instrument(s) may also be connected to the switching system 104. Setting up the switching system 104 may include installing one or more switch devices in the switching system 104.

In step 303, switch configuration information may be stored. For example, the user may use a switch executive program such as described above to specify and store the switch configuration information. As described above, the switch configuration information may include information such as which switch devices make up the switching system (e.g., by defining a virtual device 105 that includes one or more actual switch devices), alias names assigned to channels/pins, defined hardwire connections, etc. The switch configuration information may also include one or more pre-configured routes, wherein each route specifies a path between two switch device channels, wherein the channels may be on the same switch device or on different switch devices. The switch configuration information may also include one or more pre-configured route groups, wherein each route group references one or more pre-configured routes.

In step 305, a test executive sequence configured to perform one or more hardware switching operations may be created. The test executive sequence may include one or more steps configured to perform one or more hardware switching operations. In one embodiment, the user may reference the switch configuration information stored in step 303 as the test executive sequence is created. For example, the user may configure a step to connect one or more pre-configured routes or route groups. One embodiment of a method for configuring a test executive sequence to perform one or more hardware switching operations is described below.

In step 307, the test executive sequence may be executed. Executing the test executive sequence may include executing one or more steps included in the test executive sequence that are configured to perform one or more hardware switching operations. Thus, executing these steps may include performing the respective hardware switching operation(s). For example, as described above, the hardware switching operations may affect the configuration of one or more switch devices to facilitate the testing of a UUT as the test executive sequence executes.

It is noted that FIG. 9 illustrates a representative embodiment, and alternative embodiments are contemplated. Also, various steps may be combined, omitted, or performed in different orders. As one example, in one embodiment, the test executive sequence may be configured to perform one or more hardware switching operations without referencing pre-stored switch configuration information. Thus, step 303 may not be performed.

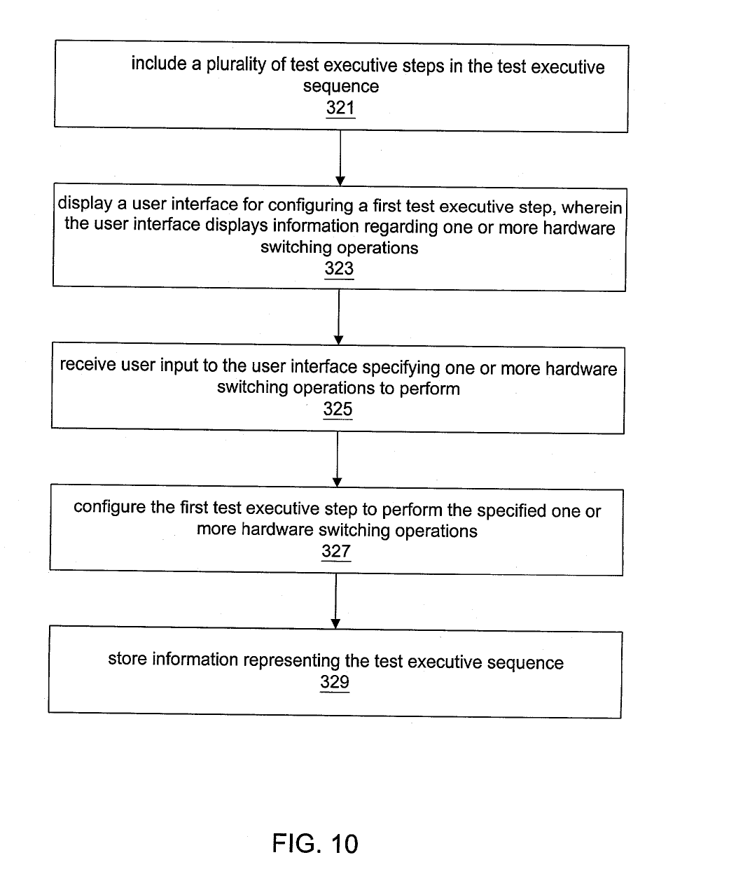

FIG. 10—Creating a Test Executive Sequence Configured to Perform One or more Hardware Switching Operations

FIG. 10 is a flowchart diagram illustrating one embodiment of a method for creating a test executive sequence configured to perform one or more hardware switching operations. It is noted that FIG. 10 illustrates a representative embodiment, and alternative embodiments are contemplated. Also, various steps may be combined, omitted, or performed in different orders.

In step 321, a plurality of test executive steps may be included in the test executive sequence, e.g., in response to user input, as described above.

In step 323, a user interface for configuring a first test executive step (i.e., a particular step) in the test executive sequence may be displayed, wherein the user interface displays information regarding one or more hardware switching operations.

In step 325, user input may be received to the user interface, wherein the user input specifies one or more hardware switching operations to perform. The user interface may display information enabling the user to specify the one or more hardware switching operations to perform without requiring user programming or without requiring the user to write source code.

In various embodiments, the user interface may enable the user to specify any of various kinds of hardware switching operations. Exemplary hardware switching operations are described below. In one embodiment, in specifying a hardware switching operation, the user may specify a portion of previously stored switch configuration information, such as described above with reference to FIG. 9. As one example, if the switch configuration information includes pre-configured routes and the user desires the first test executive step to connect and/or disconnect one or more of the routes, the user may specify the desired route names to connect and/or disconnect.

In step 327, the first test executive step may be configured to perform the specified one or more hardware switching operations. For example, the step may be configured to invoke program instructions during execution of the test executive sequence that will cause the specified one or more hardware switching operations to be performed.

In step 329, information representing the test executive sequence may be stored. For example, the test executive sequence may be represented using one or more data structures stored on a memory medium. As described above with reference to FIG. 9, after the test executive sequence has been created, the sequence may be executed.

As noted above, in various embodiments the first test executive step may be configured to perform various kinds of hardware switching operations. In one embodiment, the step may be configured to perform a connect operation to cause connections to be made in one or more switch devices, and/or the step may be configured to perform a disconnect operation to cause disconnections to be made in one or more switch devices. For example, in step 325 the user may specify one or more routes to connect and/or disconnect.

For example, in specifying the one or more routes, the user may specify one or more of: one or more route names, wherein each route name references a pre-configured route; one or more route groups, wherein each route group references a plurality of pre-configured routes; and/or a fully specified path between a source channel and a destination channel. In one embodiment, the one or more routes may be specified by a route specification string that includes a series of routes delimited by ampersands, such as:

routeOrGroup {& routeOrGroup} {& routeOrGroup} . . .

where routeOrGroup can be one of the following:

a route name

a route group name

a fully specified path

For example, a fully specified path may be enclosed in square brackets and may include a series of channels delimited by “->”, such as:

[channel {->channel} {->channel} . . . ]

where a channel may be one of the following:

a channel alias name

a unique name created by combining a device logical name and channel name separated by a “!” delimiter, such as by combining an IVI device logical name and IVI channel name separated by a “!” delimiter.

a channel name, such as an IVI channel name

In one embodiment, the channels on either end of a bracketed fully specified path must not be configuration channels or hardwired channels, and only one end channel can be a source channels. Also, in one embodiment, the inner channels must be either configuration channels or hardwired channels.

The following shows an examplary route specification string,

MyRouteGroup & MyRoute & [Dev1!CH3->CH4,CH4->RO]

In addition to connect and disconnect operations, the first test executive step may be configured to perform various other kinds of hardware switching operations. Exemplary hardware switching operations include: determining connectivity between channels in one or more switch devices; querying one or more switch devices for information; causing one or more switch devices to perform a scanning operation; perform a wait operation, wherein the wait operation comprises waiting for one or more switches to debounce; configuring one or more switches in one or more switch devices; sending a software trigger command to one or more switch devices; etc.

In an embodiment in which the test executive software supports step types such as described above, the test executive software may implement a switch step type. In this case, the first test executive step may be an instance of a switch step type. The switch step type may be a specialized step type for performing hardware switching operations. One embodiment of a switch step type is described in detail below.

In another embodiment, the test executive software may not support the use of step types, or the first test executive step may be an instance of a type other than a specialized switch step type. However, the user may still be able to configure the step to perform one or more hardware switching operations. For example, each step in the test executive sequence may have an associated user interface for configuring general properties of the respective step, such as described above with reference to FIG. 8. This user interface may enable the user to specify properties of the step related to hardware switching operations, e.g., may enable the user to configure the step to perform one or more hardware switching operations. Thus, the user may be able to configure the step to perform one or more hardware switching operations regardless of the type of step.

Where the first test executive step is configured to call a code module, the user may utilize the user interface to specify one or more hardware operations to be performed before and/or after execution of the code module. For example, the user may specify a connect and/or disconnect operation to be performed before and/or after the respective code module executes during execution of the test executive sequence. As one example, the user may specify a connect operation to be performed before the code module executes and a disconnect operation to be performed after the code module executes.

Although FIG. 10 refers to a single step in the test executive sequence being configured to perform a hardware switching operation(s), in various embodiments any number of steps in the sequence may configured to perform hardware switching operations. Also, as noted above, FIG. 10 represents an exemplary embodiment of the method, and alternative embodiments are contemplated. For example, in one embodiment the test executive sequence may be created programmatically and steps in the sequence may be configured programmatically, without requiring user input. For example, a client program may utilize an API of the test executive software to programmatically create and configure the sequence.

Exemplary Embodiments of a Switch Step Type

One embodiment of a switch step type may provide a high-level programming layer for instruments that are compliant with the Interchangeable Virtual Instruments (IVI) Switch class. The switch step type may support IVI-compliant instruments (switch devices) that can perform triggered scanning and trigger-synchronized establishing or breaking of the paths. In one embodiment, the switch step type may support the following IVI hardware switching operations:

Connect/Disconnect—Connects or disconnects source and destination channels in the switch device.

Configure Scan—configures the switch module for scanning.

Start Scan—Initiates a scanning operation.

Wait—Blocks until all switches debounce for a device.

Configure Switch—Configure channels as configuration or source channels, and configure specific paths between channels.

Send Software Trigger—Sends a software trigger command to trigger the switch device during a scanning operation.

Abort Scan—Cancels a scanning operation.

Get Information—Retrieves low-level status and information from the switch device.

Another embodiment of the switch step type may provide a high-level programming layer for a Switch Executive virtual device.

In one embodiment, the switch step type may support the following Switch Executive hardware switching operations:

Connect/Disconnect—Connects or disconnects switch routes for a virtual device.

Wait—Blocks until all switches debounce for a virtual device.

Get Information—Retrieves low-level status and information from a virtual device.

In one embodiment, a switch step type may support both IVI-compliant switch devices and Switch Executive virtual devices, and the user may choose which mode to use, i.e., an IVI Switching mode or a Switch Executive mode. For example, the user interface of the switch step type may enable the user to select which mode to use. The following sections describe one such embodiment.

Connect/Disconnect

The Connect/Disconnect operation is available for both the IVI Switching and Switch Executive modes. For the IVI Switching mode, the operation may connect/disconnect paths for a specified IVI logical name. For the Switch Executive mode, the operation may connect/disconnect routes for a specified virtual device name.

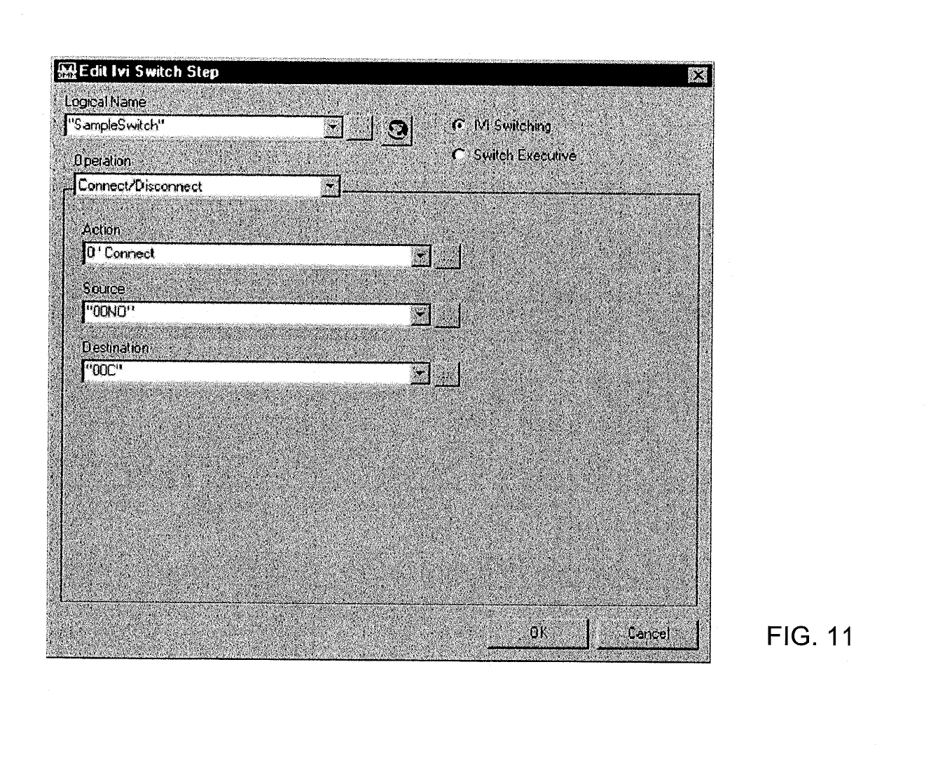

FIG. 11 shows a user interface for configuring a step having a switch step type, where the Connect/Disconnect operation and the IVI Switching mode are selected. The user interface includes the following controls:

Action—Specifies whether to connect or disconnect a path between the specified source and destination channels, or disconnect all previously connected paths. This operation returns as soon as the instrument (switch device) is ready for another operation. This may be before or after the switches involved settle. The user may use the Wait operation if the user wants to wait until all switches have debounced.

Supported values:

Connect (0) Creates a path between the specified source and destination channels.

Disconnect (1) Destroys the path between the specified source and destination channels.

Disconnect All (2) Disconnects all paths previously created.

Source—Specifies the name of a source channel being connected or disconnected. The string expression may evaluate to be a valid virtual channel name as defined by the IVI configuration for the specified logical name.

Destination—Specifies the name of a destination channel being connected or disconnected. The string expression may evaluate to be a valid virtual channel name as defined by the IVI configuration for the specified logical name.

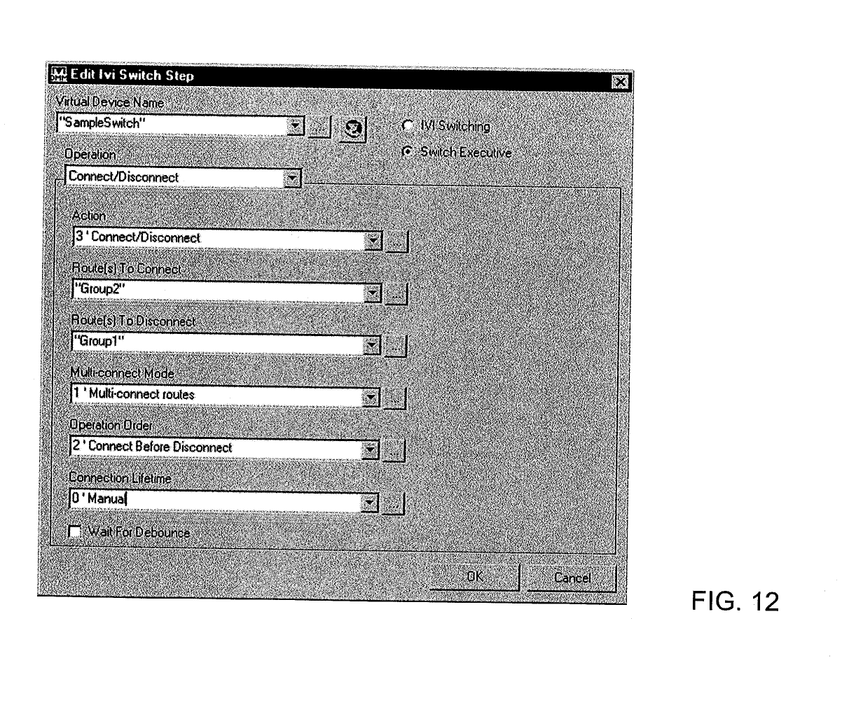

FIG. 12 shows a user interface for configuring a step having a switch step type, where the Connect/Disconnect operation and the Switch Executive mode are selected. The user interface includes the following controls:

Action—Specifies whether to connect or disconnect specified routes, or disconnect all previously connected routes. This operation returns as soon as the instrument is ready for another operation. This may be before or after the switches involved settle. The user may use the Wait For Debounce option if the user wants to wait until all switches have debounced.

Supported values:

Connect (0)—Creates paths defined by the specified routes in the Routes to Connect control.

Disconnect (1)—Disconnects paths defined by the specified routes in the Routes to Disconnect control.

Disconnect All (2)—Disconnects all paths previously created.

Connect/Disconnect (3)—Creates paths defined by the routes specified in the Routes to Connect control, and destroys paths defined by the routes specified in the Routes to Disconnect control. The user may use the Operation order option to specify whether the disconnect operation occurs before or after the connect operation.

Route(s) to Connect—Specifies the routes to connect. The expression may be a valid route specification string for the specified virtual device name, as defined by a switching configuration, e.g., a switching configuration specified using a Switch Executive application such as described above. The string may also be a combination of route group alias names, route names, and physical route paths.

Route(s) to Disconnect—Specifies the routes to disconnect. The expression may be a valid route specification string, similarly as for the Route(s) to Connect control.

Multi-Connect Mode—Specifies behavior when more than one connection operation occurs on a specific route.

Supported values:

No Multi-Connect (0)—Specifies that a route can only be connected once. Any attempts to reconnect a route that is already connected results in an error.

Multi-Connect Routes (1)—Specifies that a route can be connected multiple times. The routes may be automatically reference-counted. If multiple connect operations are issued for a route, the route may not be physically disconnected until an equal number of disconnect operations occur. A disconnect operation may be issued manually, or a lifetime setting for the route may be used. The Disconnect All operation may disconnect a route even if the route reference count is greater than one.

Operation Order—Specifies whether a disconnect operation occurs before or after a connect operation.

Supported values:

Disconnect Before Connect (1)—Disconnect the specified routes before connecting any routes. This is the typical mode of operation.

Connect Before Disconnect (2)—Connect the specified routes before disconnecting any routes. This mode of operation may be used when switching current, e.g., to ensure that a load is always connected to the source.

Connection Lifetime Specifies the lifetime applied to the routes specified for the Connect or Connect/Disconnect actions. The user can specify whether he wants the route to exist until manually disconnected later, or until the step, sequence, thread or execution completes. If the multi-connect route mode is used, a route can exist longer if another step specifies its own lifetime for the same route. Selecting a lifetime other than manual guarantees that the route stays connected as long as the step, sequence, thread, or execution in which it is connected is still executing. If a route is manually disconnected that was previously connected using a non-manual lifetime setting, the reference to the route may be released for the last step that performed a connect action for that route.

Wait for Debounce -Specifies whether the operation waits for all switches to debounce before returning. The wait for debounce occurs after both connect and disconnect operations are complete.

Configure Scan

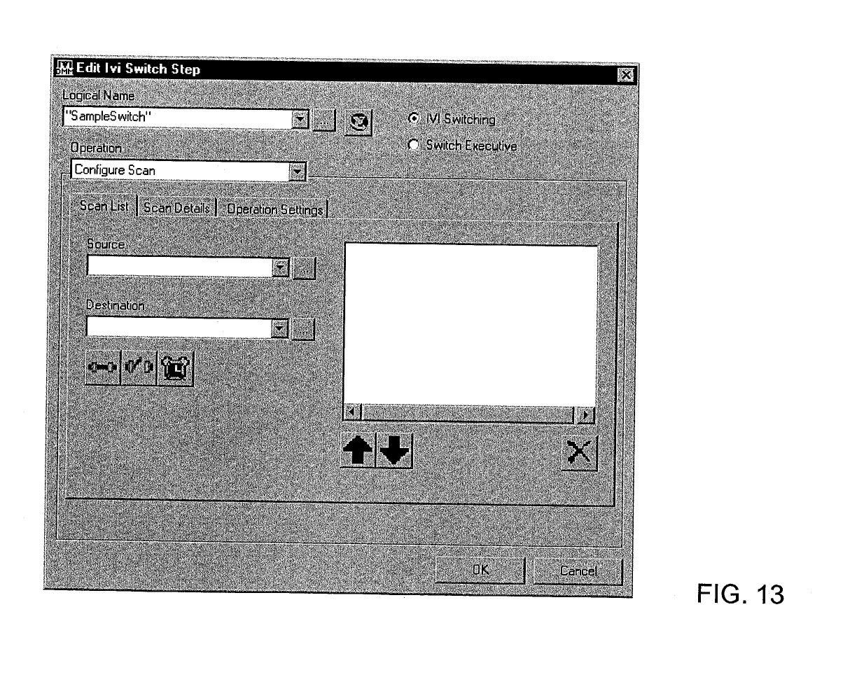

The Configure Scan operation is only available for the IVI Switching mode, and the switch must support the IVI Scanner extension. This operation configures the switch module for scanning. FIG. 13 shows a user interface for configuring a step having a switch step type, where the Configure Scan operation and the IVI Switching mode are selected. The user interface has multiple tabs. A Scan List tab allows the user to set the scan list, and the Scan Details tab allows the user to set other scan-related options. Once the scan list is configured, the user may use the Start Scan operation to instruct the instrument to initiate the scan.

In FIG. 13, the Scan List tab is selected. The Scan List tab allows the user to build a list of scanning actions. Scanning actions include connecting a path, disconnecting a path, and waiting for a trigger. The three command buttons below the destination control insert new items into the list control. The Connect button inserts a connect path item into the scan list using the specified source and destination channels. The Disconnect button inserts a disconnect path item into the scan list using the specified source and destination channels. The Wait for Trigger button inserts a wait for trigger item into the scan list. The up and down arrow buttons allow the user to reorder the items in the scan list, and the delete button allows the user to remove an item from the list.

The Scan List tab includes the following controls:

Source—Specifies the name of a source channel being connected or disconnected. The string expression may evaluate at run-time to a valid virtual channel name as defined by the IVI configuration for the specified logical name.

Destination -Specifies the name of a destination channel being connected or disconnected. The string expression may evaluate at run-time to a valid virtual channel name as defined by the IVI configuration for the specified logical name.

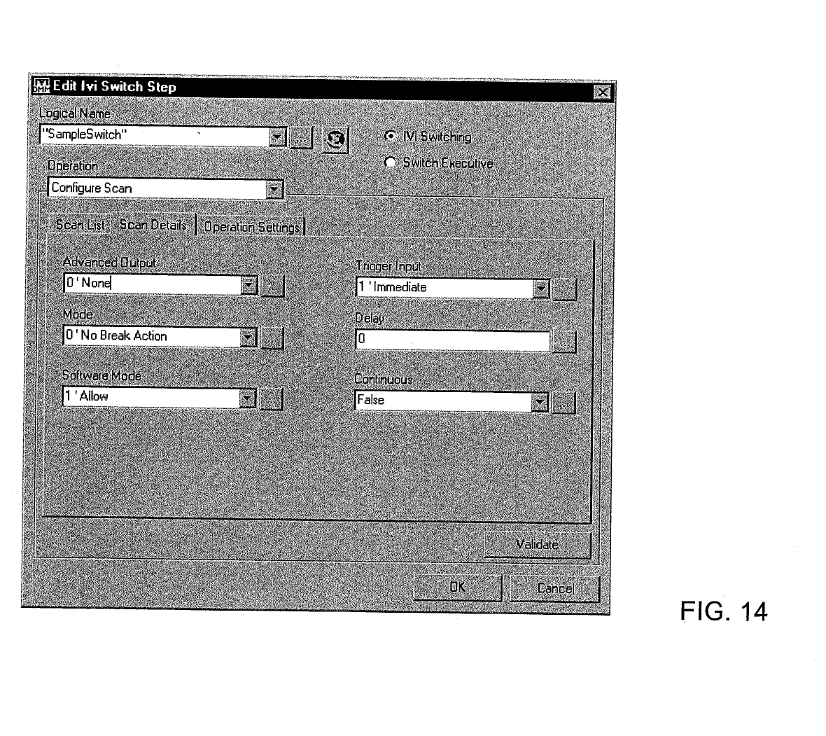

FIG. 14 shows the user interface of FIG. 13, where the Scan Details tab is selected. The Scan Details tab includes the following controls:

Advanced Output—Specifies where the instrument (switch device) routes the scan advanced output trigger. This trigger asserts each time the instrument creates a path. The trigger may not assert until sufficient settling time is provided for the path.

Supported values:

None (0)—No trigger is sent out of the switch module.

External (2)—The switch sends a trigger to an external device through a trigger output connection.

GPIB SRQ (5)—The switch sends a GPIB SRQ event.

TTL0 (111)—The switch asserts TTL0.

TTL1 (112)—The switch asserts TTL1.

TTL2 (113)—The switch asserts TTL2.

TTL3 (114)—The switch asserts TTL3.

TTL4 (115)—The switch asserts TTL4.

TTL5 (116)—The switch asserts TTL5.

TTL6 (117)—The switch asserts TTL6.

TTL7 (118)—The switch asserts TTL7.

ECL0 (119)—The switch asserts ECL0 line.

ECL1 (120)—The switch asserts ECL1 line.

PXI Star (125)—The switch asserts PXI Star trigger bus.

RTSI0 (140)—The switch asserts RTSI0.

RTSI1 (141)—The switch asserts RTSI1.

RTSI2 (142)—The switch asserts RTSI2.

RTSI3 (143)—The switch asserts RTSI3.

RTSI4 (144)—The switch asserts RTSI4.

RTSI5 (145)—The switch asserts RTSI5.

RTSI6 (146)—The switch asserts RTSI6.

Mode—Specifies whether the connections made in the previous trigger event must be broken, and if so, how they must be broken.

Supported values:

No Action (0)—Indicates that no action must be taken on the previous paths.

Break Before Make (1)—Break the previous paths before making the new paths. This is useful if the user wants to prevent two channels from connecting together in the transitional period.

Break After Make (2)—Make new paths before breaking the previous paths. This is useful if the user wants to prevent damage from occurring on inductive elements of a circuit that cannot stand rapid changes in the current flow.

Software Mode—Specifies whether the scan is executed in hardware or software.

Supported values:

Disable (0)—Assures hardware scanning. If hardware scanning fails, the attempt to scan fails.

Allow (1)—Attempts hardware scanning, and, if that fails, uses software scanning.

Force (2)—Assures software scanning. There is no attempt to scan with hardware

Trigger Input -Specifies the source of the trigger input. The trigger tells the switch module to advance to the next entry in the scan list and set the specified path.

Supported values:

Immediate (1)—The switch module does not wait for a trigger before starting the next entry in the scan list. This option is typically used for switch modules that support the Scan Delay option and can therefore have the switch module pace itself.

External (2)—The trigger comes from an external source through a trigger input connection.

Software (3)—The switch waits for a trigger until the Send Software Trigger operation executes.

TTL0 (111)—The switch waits for a trigger on TTL0.

TTL1 (112)—The switch waits for a trigger on TTL1.

TTL2 (113)—The switch waits for a trigger on TTL2.

TTL3 (114)—The switch waits for a trigger on TTL3.

TTL4 (115)—The switch waits for a trigger on TTL4.

TTL5 (116)—The switch waits for a trigger on TTL5.

TTL6 (117)—The switch waits for a trigger on TTL6.

TTL7 (118)—The switch waits for a trigger on TTL7.

ECL0 (119)—The switch waits for a trigger on the ECL0 line.

ECL1 (120)—The switch waits for a trigger on the ECL1 line.

PXI Star (125)—The switch waits for a trigger on the PXI Star trigge r bus.

RTSI0 (140)—The switch waits for a trigger on RTSI0.

RTSI1 (141)—The switch waits for a trigger on RTSI1.

RTSI2 (142)—The switch waits for a trigger on RTSI2.

RTSI3 (143)—The switch waits for a trigger on RTSI3.

RTSI4 (144)—The switch waits for a trigger on RTSI4.

RTSI5 (145)—The switch waits for a trigger on RTSI5.

RTSI6 (146)—The switch waits for a trigger on RTSI6.

Delay—Specifies the minimum length of time in milliseconds from when the path is created to when the scan advanced output trigger is asserted. Due to the design of the switch module, the actual delay time may be longer than the Scan Delay value.

Continuous—Specifies whether the scan restarts from the beginning of the scan list when it reaches the end of the scan list.

The Operations Settings tab of the user interface of FIGS. 13 and 14 may enable the user to specify to which property or variable, e.g., which test executive sequence property or variable, the step saves the operation settings to when closing the edit dialog, and may reload the operation settings from this property or variable when displaying the edit dialog.

Start Scan The Start Scan operation is only available for the IVI Switching mode. This operation initiates a scan using a scan list previously defined using a Configure Scan operation. The Start Scan operation returns once the scan begins. To stop the scanning operation, the user may use the Abort Scan operation.

The instrument may generate the first scan advanced output trigger after the Start Scan operation. If the switch module activates the first switch upon the download of the scan list, the instrument may ensure that no scan advanced output trigger is generated. Once the switch module is scanning, operations other than Send Software Trigger, Start Scan, and Abort Scan may be invalid. Calling the Start Scan operation during a scan may return the switch module to the default state and begin the scan over again.

Wait

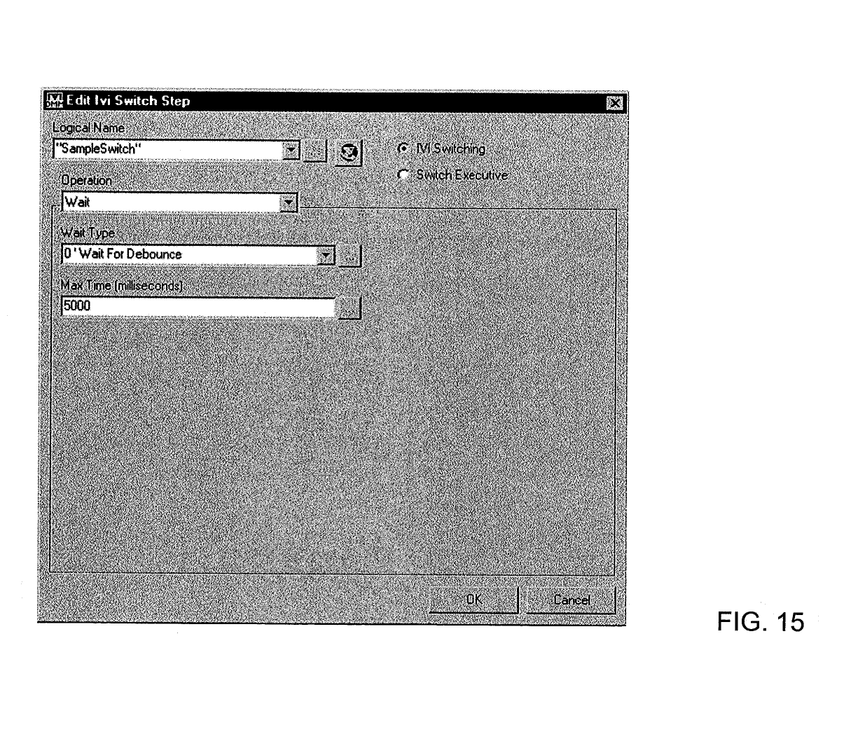

The Wait operation is available for both the IVI Switching and the Switch Executive modes. The Wait operation can wait for debounce in either mode, or wait for completion of a scan when in IVI Switching mode. FIG. 15 shows a user interface for configuring a step having a switch step type, where the Wait operation and the IVI Switching mode are selected. The user interface includes the following controls:

Type—Specifies whether to wait for debounce or wait for completion of a scan.

Supported values:

Wait for Debounce (0)—Waits until all the signals flowing through the switch have settled.

Wait for Scan Complete (1)—Waits until the instrument stops scanning through the scan list. This value only applies to the IVI Switching mode.

Max Time—Specifies the number of milliseconds that the switch module waits for a successful debounce or completion of a scan. The user can specify a maximum length of time in milliseconds to wait. If the time specified elapses, the operation returns a timeout error.

Configure Switch

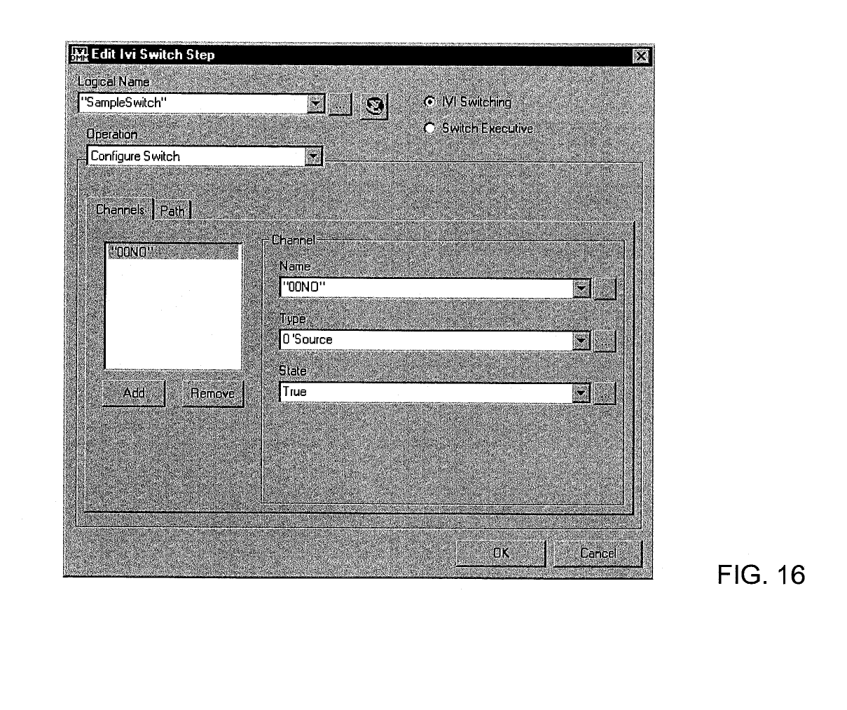

The Configure Switch operation is only available in the IVI Switching mode. FIG. 16 shows a user interface for configuring a step having a switch step type, where the Configure Switch operation and the IVI Switching mode are selected. The user interface has two tabs, the Channels tab and the Paths tab. The Channels tab allows the user to specify which channels are configuration or source channels. The Paths tab allows the user to set specific paths between channels.

In FIG. 16, the Channels tab is selected. If the user specifies a column-to-column connection in a matrix, the specific driver typically must use at least one row channel to make the connection. Specifying a channel as a configuration channel allows the instrument driver to use the channel to create the path.

If the user attempts to connect two channels that are either sources or have their own connections to sources, the connection operation may return an error. The term “source” may be from either the instrument or the UUT perspective. As a result, the driver may ensure for each connection that another connection within the switch module does not connect to another source. Defining a channel as a source may prevent channels from being connected that might cause damage to the channels, devices, or system.

The Channels tab contains a list control with a list of channels. The user can use the Add and Remove buttons to add new channels and remove existing channels from the list. The user can specify whether to set or reset the state of the channel either as a configuration or a source channel. The Channels tab contains the following channelspecific controls pertaining to a currently-selected channel:

Name—Specifies the name of the channel. The channel name may evaluate to be a valid virtual channel name as defmed by the IVI configuration for the specified logical name.

Type Specifies the type of channel for which its state is set.

Supported values:

Configuration (0)—The specific driver reserves the channel as a configuration channel for internal path creation.

Source (1)—The specific driver reserves the channel as a source channel.

State—Specifies whether the configuration or source channel state is set or reset. A value of True adds the channel to the configuration or source channel list. A value of False removes the channel from either the configuration or source channel list.

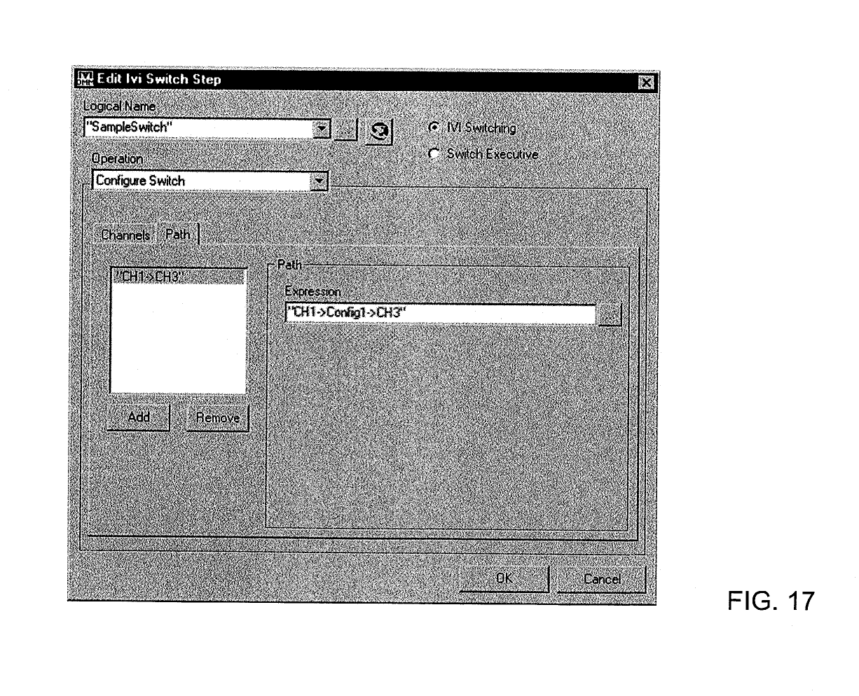

FIG. 17 shows the user interface of FIG. 16, where the Paths tab is selected. Due to such issues as calibration, the user might want to have deterministic control over the path that the instrument creates between two channels. The Paths tab allows the user to specify the exact path to create, e.g., with respect to the configuration channels used in the path.

The instrument (switch device) may make a connection between the source and destination channels using configuration channels. These intermediary steps may be called the legs of the path. The path syntax is a comma-delimited list of path legs that obeys the following rules: 1) The second channel of a leg in the path is the same as the first channel in the subsequent leg; and 2) Every channel in the path other than the first and last channels is a configuration channel. An example of a path is:

“ch1->conf1,conf1->ch2”

A “˜” character may be used to denote disconnecting the specified path.

The Paths tab includes a list control with a list of paths. The display name in the list control displays the end channel names from the specified path. The user can use the Add and Remove buttons to add new paths and remove existing paths from the list. The Expression control specifies the expression that is evaluated at run-time to determine the path to set.

Send Software Trigger

The Send Software Trigger operation sends a software trigger command to trigger the instrument (switch device). This operation does not affect the behavior of the instrument if the Trigger Input option is not set to Software.

Abort Scan

The Abort Scan operation stops a previously initiated scan from a Start Scan operation, and returns the instrument to an idle state. This operation does not reset the switch module or initialize the state of the switch module. The switch module is simply desensitized from triggers and moves to an idle state. If the switch module is not currently scanning through the scan list, this operation returns an error.

Get Information

The Get Information operation retrieves low-level status and information from the instrument or virtual device. This operation is available for both the IVI Switching and the Switch Executive modes. When the user selects IVI Switching mode, the Get Information operation allows the user to acquire switch information and channel information. When the user selects Switch Executive mode, the Get Information operation allows the user to find routes and determine whether the virtual device is debounced.

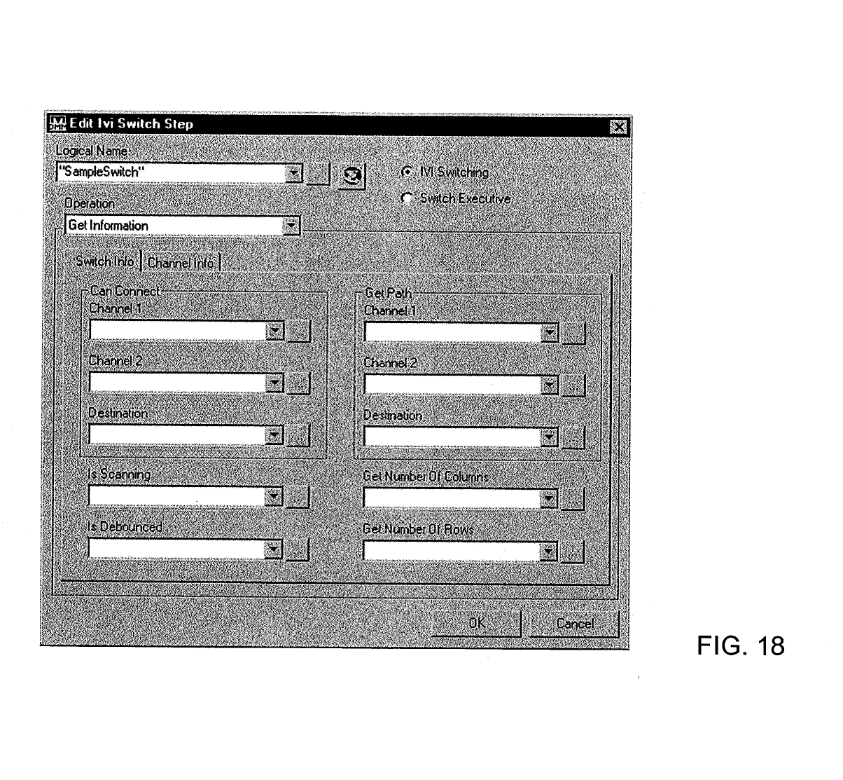

FIG. 18 shows a user interface for configuring a step having a switch step type, where the Get Information operation and the IVI Switching mode are selected. The user interface has two tabs, the Switch Info tab and the Channel Info tab. In FIG. 18, the Switch Info tab is selected. The Switch Info tab includes the following controls:

Can Connect—Returns a value indicating whether the switch module can create a given path, but without actually creating the path. The Channel controls specify the end points of the prospective path. The Destination control specifies a variable or property to which a return value is assigned. A successful connection can be made when the Can Connect return value is Path Available. Any other return value gives a reason why an attempt at a connection between the channels fails. If an implicit connection exists between the two specified channels, this operation returns a warning that notifies the user that the connection already exists.

Supported return values:

Channel Not Available (6)—Specifies that the driver cannot create a path between the two channels because one of the channels is a configuration channel and thus unavailable for external connections.

Path Available (1)—Specifies that the driver can create a path at this time.

Path Exists (2)—Specifies that the explicit path between the channels already exists.

Path Unsupported (3)—Specifies that the instrument is not capable of creating a path between the two channels.

Resource In Use (4)—Specifies that although the path is valid, the driver cannot create the path at this moment because the switch module is currently using one or more of the required channels to create another path. The user must destroy the other path before creating this one.

Source Conflict (5)—Specifies that the instrument cannot create a path between the two channels because both are connected to a different source channel.

Is Scanning—Specifies a variable or property to which the step assigns a value indicating whether the switch module is currently scanning through the scan list. This is one way to determine if the switch module scanning is complete. The user can also use the Wait operation using the Wait For Scan Complete option, which blocks until the scan is complete. If the instrument is waiting for a trigger, a value of True is returned.

Is Debounced—Specifies a variable or property to which the step assigns a value indicating whether or not all signals flowing through the switch have settled and it is safe to make a measurement at this time.

Get Path—Returns the list of connections, as comma-delimited channel pairs, that were established to connect the two given channels. The Channel 1 and Channel 2 controls specify the end points for the path the user wants to retrieve. The Destination control specifies a variable or property to which the step assigns the path. The user may use Get Path to better understand the signal characteristics of the path and to provide an explicit path for Set Path in the Configure Scan operation. The first and last names in the path are the source and destination channel names of the path, and all others channels in the path are configuration channels. If no explicit path exists between the two specified channels, an error may be returned.

Get Number of Columns—Specifies a variable or property to which the step assigns a value indicating the maximum number of channels on the column of a matrix or scanner. If the switch module is a scanner, this value is the number of input channels. The number returned is dependent on the wire mode settings.

Get Number of Columns—Specifies a variable or property to which the step assigns a value indicating the maximum number of channels on the row of a matrix or scanner. If the switch module is a scanner, this value is the number of output channels (commons) of the scanner. The number returned is dependent on the wire mode settings.

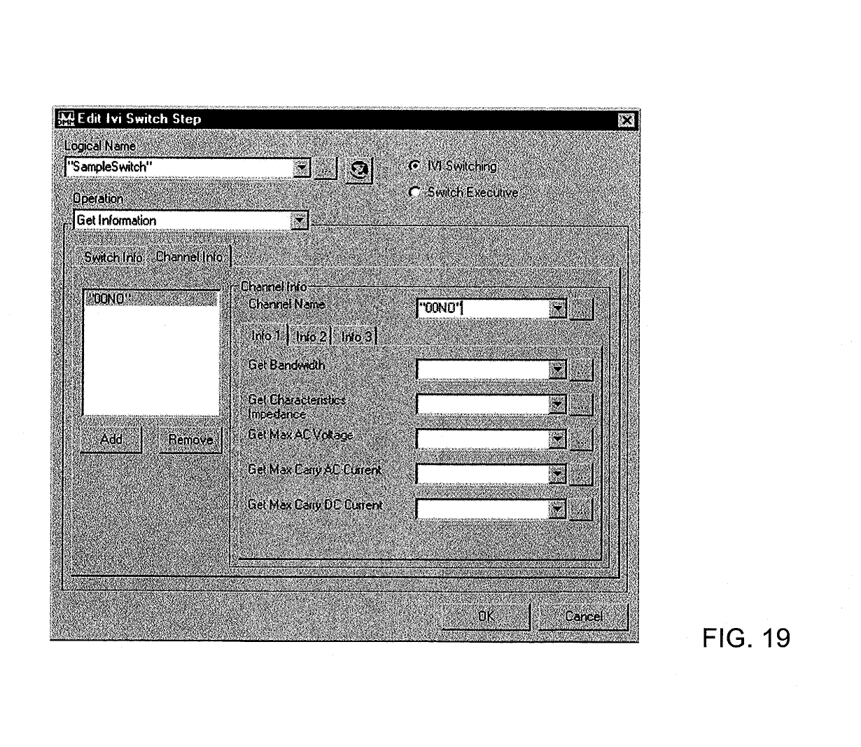

FIG. 19 shows the user interface of FIG. 18, where the Channel Info tab is selected. The Channel Info tab includes a list control with a list of channels. The user can use the Add and Remove buttons to add new channels and remove existing channels from the list. The Channel Info section of the tab allows the user to retrieve specific information for the currently selected channel. The Channel Info section has three tabs, Info1, Info2 and Info3. In FIG. 19, the Info1 tab is selected. The Info 1 tab includes the following channel-specific controls:

Name—Specifies the name of a channel. The channel name may evaluate to be a valid virtual channel name as defined by the IVI configuration for the specified logical name.

Get Bandwidth—Specifies a variable or property to which the step assigns a value indicating the bandwidth of the channel in hertz. The value is on a per-channel basis and might not take into account the other switches that make up a path to or from this channel.

Get Characteristic Impedance—Specifies a variable or property to which the step assigns a value indicating the characteristic impedance of the channel in ohms. The value is on a per-channel basis and might not take into account the other switches that make up a path to or from this channel.

Get Max AC Voltage—Specifies a variable or property to which the step assigns a value indicating the maximum AC voltage in volts RMS that the channel can handle. The value is on a per-channel basis and might not take into account the other switches that make up a path for this channel.

Get Max Carry AC Current—Specifies a variable or property to which the step assigns a value indicating the maximum AC current in amperes that the channel can carry. The value is on a per-channel basis and might not take into account the other switches that make up a path to or from this channel.

Get Max Carry DC Current—Specifies a variable or property to which the step assigns a value indicating the maximum DC current in amperes that the channel can carry. The value is on a per-channel basis and might not take into account the other switches that make up a path to or from this channel.

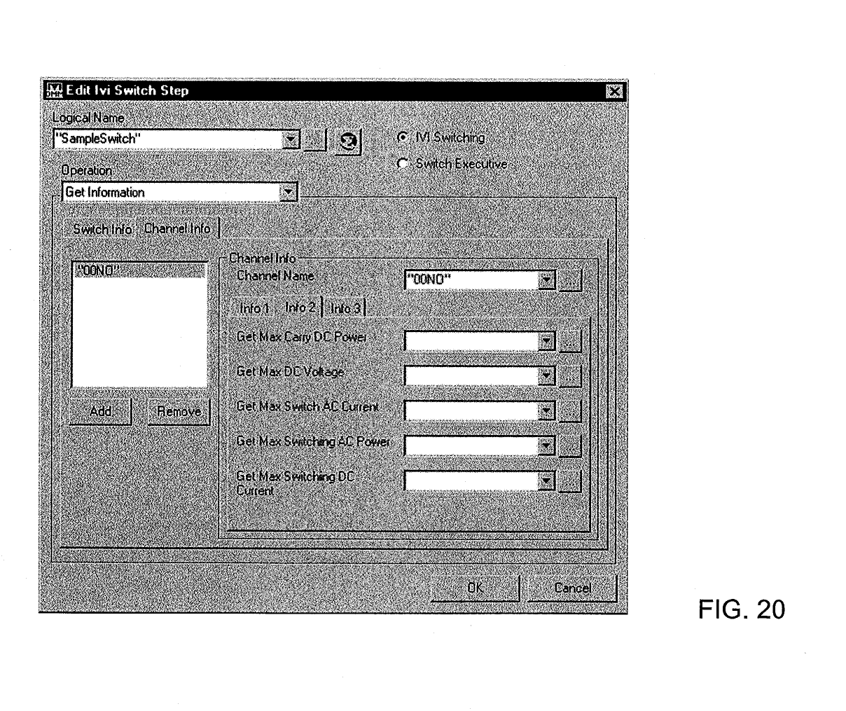

FIG. 20 shows the user interface of FIG. 19, where the Info2 tab is selected. The Info2 tab includes the following channel-specific controls:

Get Max Carry DC Power—Specifies a variable or property to which the step assigns a value indicating the maximum DC power in watts that the channel can handle. The value is on a per-channel basis and might not take into account the other switches that make up a path to or from this channel.

Get Max DC Voltage—Specifies a variable or property to which the step assigns a value indicating the maximum DC voltage in volts that the channel can handle. The value is on a per-channel basis and might not take into account the other switches that make up a path to or from this channel.

Get Max Switch AC Current—Specifies a variable or property to which the step assigns a value indicating the maximum AC current in amperes that the channel can switch. The value is on a per-channel basis and might not take into account the other switches that make up a path to or from this channel.

Get Max Switching AC Power—Specifies a variable or property to which the step assigns a value indicating the maximum AC power in volt-amperes that the channel can switch. The value is on a per-channel basis and might not take into account the other switches that make up a path for this channel.

Get Max Switching DC Current—Specifies a variable or property to which the step assigns a value indicating the maximum DC current in amperes that the channel can switch. The value is on a per-channel basis and might not take into account the other switches that make up a path to or from this channel.

Get Max Switching DC Power—Specifies a variable or property to which the step assigns a value indicating the maximum DC power in watts that the channel can switch. The value is on a per-channel basis and might not take into account the other switches that make up a path to or from this channel.

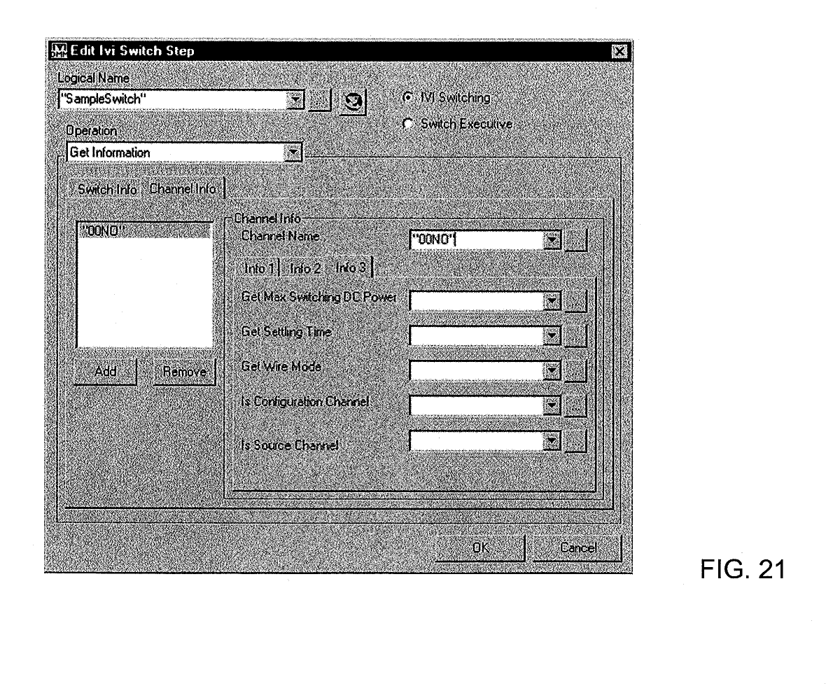

FIG. 21 shows the user interface of FIGS. 19 and 20, where the Info3 tab is selected. The Info3 tab includes the following channel-specific controls:

Get Settling Time—Specifies a variable or property to which the step assigns a value indicating the maximum total settling time, in seconds, for the channel before the signal going through it is considered stable. The returned value includes both the activation time for the channel as well as any debounce time. The value is on a per-channel basis and might not take into account the other switches that make up a path to or from this channel.

Get Wire Mode—Specifies a variable or property to which the step assigns a value indicating the number of conductors in the current channel. The value is on a perchannel basis and might not take into account the other switches that make up a path to or from this channel.

Is Configuration Channel—Specifies a variable or property to which the step assigns a Boolean value indicating whether the specific driver uses the channel for internal path creation. For example, if the user specifies a column-to-column connection in a matrix, the specific driver typically must use at least one row channel to make the connection.

Is Source Channel—Specifies a variable or property to which the step assigns a Boolean value indicating whether the particular channel is a source channel. If the user attempts to connect two channels that are either sources or have their own connections to sources, the connect operation returns an error. The term source can be from either the instrument or the UUT perspective. As a result, the driver may ensure with each connection that another connection within the switch module does not connect to another source. Defining a channel as a source may prevent other channels from being connected that might cause damage to the channels, devices, or system.

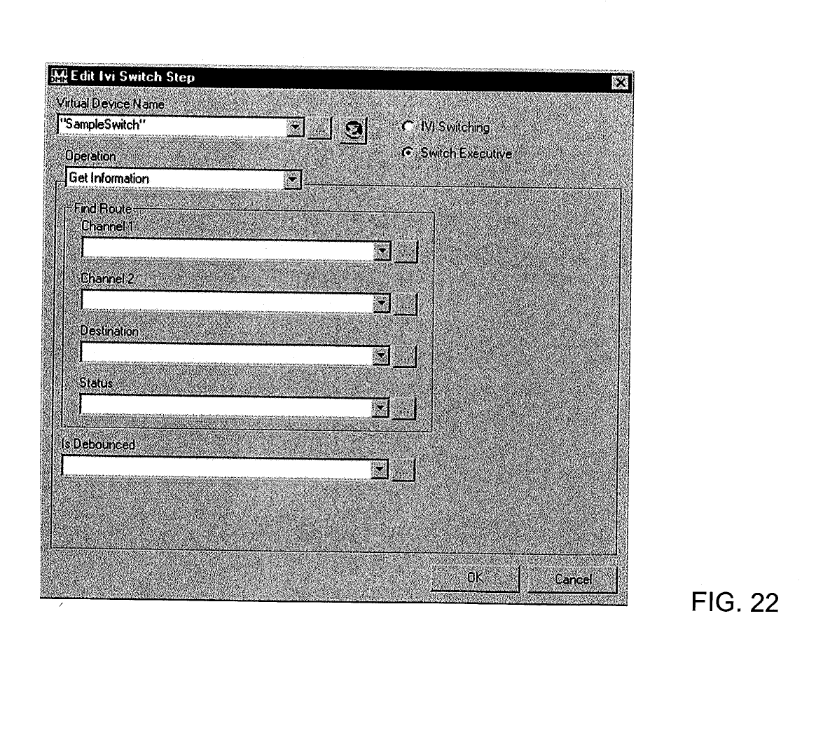

FIG. 22 shows a user interface for configuring a step having a switch step type, where the Get Information operation and the Switch Executive mode are selected.

The Find Route section takes two endpoint channels as inputs and returns a route string and enumerated status value. The Channel 1 and Channel 2 controls specify the endpoint channels to use when finding the route.

Channel 1—Specifies a first endpoint as input to find a route.

Channel 2—Specifies a second endpoint as input to find a route.

Destination—Specifies a variable or property to which the step assigns a value indicating the resulting route string. If a connection exists or if a connection can possibly be made between the two passed channels, the route string contains information that specifies the route.

Status—Specifies a variable or property to which the step assigns a status value.

Supported return values:

Channel Not Available (6)—Specifies that the driver cannot create a path between the two channels because one of the channels is a configuration channel and thus unavailable for external connections.

Path Available (1)—Specifies that the driver can create a path at this time.

Path Exists (2)—Specifies that the explicit path between the channels already exists.

Path Unsupported (3)—Specifies that the instrument is not capable of creating a path between the two channels.

Resource In Use (4)—Specifies that although the path is valid, the driver cannot create the path at this moment because the switch module is currently using one or more of the required channels to create another path. The user must disconnect the other path before creating this one.

Source Conflict (5)—Specifies that the instrument cannot create a path between the two channels because both are connected to a different source channel.

Switching Tab

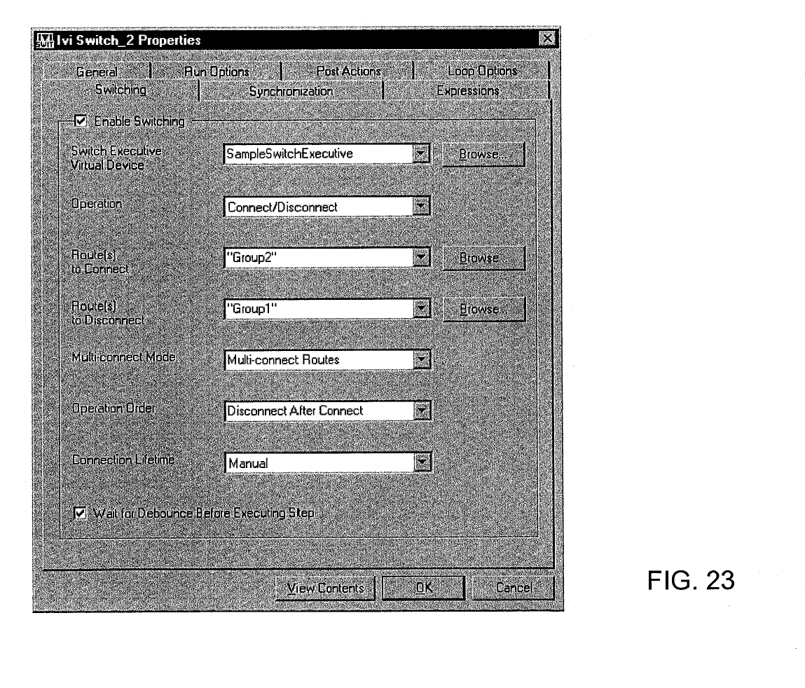

As described above, in one embodiment, a user may be able to configure a step to perform one or more hardware switching operations even if the step is not specifically designed to perform hardware switching, e.g., where the step is not an instance of a switch step type. FIG. 23 illustrates a Switching tab of a Step Properties dialog box, where the Step Properties dialog box is useable for configuring general properties of a step. The Switching tab may enable the user to specify a switching operation to be performed before and/or after execution of the step. The Switching tab includes the following controls:

Enable Switching—Specifies whether to perform the specified switching operation around the execution of the step.

Switch Executive Virtual Device—Specifies an expression to evaluate at runtime to determine a virtual device on which to perform the switching operation.

Operation—Specifies whether to connect or disconnect the specified routes, or disconnect all previously connected routes. This operation returns as soon as the instrument (switch device) is ready for another operation. This may be before or after the switches involved settle. The user may use the Wait For Debounce option to wait until all switches have debounced.

Supported values:

Connect—Connects the paths defined by the routes specified in the Routes to Connect control.

Disconnect—Disconnects the paths defined by the routes specified in the Routes to Disconnect control.

Disconnect All—Disconnects all paths previously connected.

Connect/Disconnect—Connects the paths defined by the routes specified in the Routes to Connect control, and disconnects the paths defined by the routes specified in the Routes to Disconnect control. The user may use the Operation order option to specify whether the disconnect operation occurs before or after the connect operation.

Route(s) to Connect—Specifies the routes to connect. The expression may be a valid route specification string for the specified virtual device name, as defined by a switching configuration, e.g., a switching configuration specified using a Switch Executive application such as described above. The string may also be a combination of route group alias names, route names, and physical route paths.

Route(s) to Disconnect—Specifies the routes to disconnect. The expression may be a valid route specification string, similarly as for the Route(s) to Connect control.

Multi-connect Mode—Specifies the behavior when more than one connection operation occurs on a specific route.

Supported values:

No Multi-Connect—A route can only be connected once. Any attempts to reconnect a route that is already connected results in an error.

Multi-Connect Routes—A route can be connected multiple times. The routes may be automatically reference-counted. If multiple connect operations are issued for a specific route, the route may not be physically disconnected until an equal number of disconnect operations occur. The user can either issue the disconnect operation manually, or a lifetime setting for the route may be used. The Disconnect All operation may disconnect a route even if the route reference count is greater than one.

Operation Order—Specifies whether the disconnect operation occurs before or after the connect operation.

Supported values:

Disconnect Before Connect—Disconnect the specified routes before connecting any routes. This is the typical mode of operation.

Connect Before Disconnect—Connect the specified routes before disconnecting any routes. This mode of operation may be used when switching current, e.g., to ensure that a load is always connected to the source.

Connection Lifetime—Specifies the lifetime applied to the routes specified for the Connect or Connect/Disconnect actions. The user can specify whether he wants the route to exist until manually disconnected later, or until the step, sequence, thread or execution completes. If the multi-connect route mode is used, a route can exist longer if another step specifies its own lifetime for the same route. Selecting a lifetime other than manual guarantees that the route stays connected as long as the step, sequence, thread, or execution in which it is connected is still executing. If a route is manually disconnected that was previously connected using a non-manual lifetime setting, the reference to the route may be released for the last step that performed a connect action for that route.

Wait for Debounce—Specifies whether the operation waits for all switches to debounce before returning. The wait for debounce occurs after both connect and disconnect operations are complete.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-implemented method for creating a test executive sequence, the method comprising:
including a plurality of test executive steps in the test executive sequence;
configuring a first test executive step from the plurality of steps, wherein said configuring comprises configuring the first test executive step to perform one or more hardware switching operations; and
storing information representing the test executive sequence.

2. The method of claim 1, further comprising:
executing the test executive sequence;
wherein said executing the test executive sequence comprises executing the first test executive step;
wherein said executing the first test executive step comprises performing the one or more hardware switching operations.

3. The method of claim 2,
wherein said executing the test executive sequence comprises performing one or more tests of a unit under test (UUT).

4. The method of claim 2,
wherein said executing the test executive sequence comprises executing the test executive sequence under control of test executive software to test one or more units under test (UUT).

5. The method of claim 2,
wherein said executing the first test executive step comprises interacting with one or more switch devices to perform the one or more hardware switching operations.

6. The method of claim 1, further comprising:
receiving input for configuring the first test executive step;
wherein said configuring the first test executive step to perform the one or more hardware switching operations is performed in response to the input.

7. The method of claim 1, further comprising:
displaying a user interface for configuring the first test executive step, wherein the user interface displays information regarding one or more hardware switching operations;
wherein said configuring the first test executive step to perform the one or more hardware switching operations comprises receiving user input to the user interface specifying the one or more hardware switching operations to perform.

8. The method of claim 7,
wherein user interface displays information enabling a user to specify the one or more hardware switching operations to perform without requiring user programming.

9. The method of claim 7,
wherein user interface displays information enabling a user to specify the one or more hardware switching operations to perform without requiring the user to write source code.

10. The method of claim 1,
wherein the first test executive step is an instance of a switch step type.

11. The method of claim 1,
wherein said configuring the first test executive step to perform the one or more hardware switching operations comprises configuring the first test executive step to cause connections to be made in one or more switch devices.

12. The method of claim 11, further comprising:
receiving input specifying one or more routes;
wherein said configuring the first test executive step to cause connections to be made in one or more switch devices comprises configuring the first test executive step to connect the one or more specified routes.

13. The method of claim 12,
wherein said receiving input specifying the one or more routes comprises receiving input specifying one or more of:
one or more route names;
one or more route groups; or
a path between a source channel and a destination channel.

14. The method of claim 11,
wherein said configuring the first test executive step to cause connections to be made in one or more switch devices comprises configuring the first test executive step to connect a path between a specified source channel and a specified destination channel.

15. The method of claim 1,
wherein said configuring the first test executive step to perform the one or more hardware switching operations comprises configuring the first test executive step to cause disconnections to be made in one or more switch devices.

16. The method of claim 15,
wherein said configuring the first test executive step to cause disconnections to be made in one or more switch devices comprises configuring the first test executive step to disconnect one or more specified routes.

17. The method of claim 1,
wherein said configuring the first test executive step to perform the one or more hardware switching operations comprises configuring the first test executive step to perform one or more of:
determine connectivity between channels in one or more switch devices;
query one or more switch devices for information;
cause one or more switch devices to perform a scanning operation;
perform a wait operation, wherein the wait operation comprises waiting for one or more switches to debounce;
configure one or more switches in one or more switch devices; and
send a software trigger command to one or more switch devices.

18. The method of claim 1, further comprising:
storing switch configuration information prior to said configuring the first test executive step;
wherein said configuring the first test executive step to perform the one or more hardware switching operations utilizes the switch configuration information.

19. The method of claim 18,
wherein said configuring the first test executive step to perform the one or more hardware switching operations comprises:
displaying a user interface for configuring the first test executive step; and
receiving user input to the user interface to specify the one or more hardware switching operations, wherein said receiving user input to the user interface to specify the one or more hardware switching operations comprises receiving user input specifying at least a portion of the switch configuration information.

20. The method of claim 19,
wherein said storing switch configuration information prior to said configuring the first test executive step comprises storing one or more pre-configured routes;
wherein said receiving user input to the user interface to specify the one or more hardware switching operations comprises:
receiving user input to specify one or more of a connect operation and/or a disconnect operation; and
receiving user input to specify that the connect operation and/or disconnect operation operate on the one or more pre-configured routes.

21. The method of claim 1, further comprising:
configuring the first test executive step to call a first code module during execution of the test executive sequence;
wherein said configuring the first test executive step to perform the one or more hardware switching operations comprises one or more of:
configuring the first test executive step to perform a hardware switching operation before calling the first code module; and/or
configuring the first test executive step to perform a hardware switching operation after calling the first code module.

22. A computer-implemented method for configuring a first test step, the method comprising:
displaying a user interface for configuring the first test executive step, wherein the user interface is useable for configuring the first test executive step to perform one or more hardware switching operations;
receiving user input to the user interface specifying configuration information for the first test executive step, wherein the configuration information includes information specifying one or more hardware switching operations; and
configuring the first test executive step to perform the specified one or more hardware switching operations in response to the user input.

23. The method of claim 22, further comprising:
including the first test executive step in a test executive sequence;
wherein the test executive sequence includes a plurality of test executive steps;
wherein the test executive sequence is operable to perform one or more tests of a unit under test (UUT).

24. The method of claim 23, further comprising:
executing the test executive sequence to perform the one or more tests of the UUT;
wherein said executing comprises executing the first test executive step;
wherein said executing the first test executive step comprises performing the specified one or more hardware switching operations.

25. The method of claim 22,
wherein said configuring the first test executive step to perform the specified one or more hardware switching operations comprises configuring the first test executive step to perform one or more of:
causing connections to be made in one or more switch devices;
causing disconnections to be made in one or more switch devices;
determine connectivity between channels in one or more switch devices;
query one or more switch devices for information;
cause one or more switch devices to perform a scanning operation;
perform a wait operation, wherein the wait operation comprises waiting for one or more switches to debounce;
configure one or more switches in one or more switch devices; and
send a software trigger command to one or more switch devices.

26. A computer-implemented method for creating a test executive sequence, the method comprising:
including a plurality of test executive steps in the test executive sequence in response to user input; and
configuring the plurality of test executive steps in response to user input;
wherein the plurality of test executive steps includes a first test executive step,
wherein configuring the first test executive step comprises:
configuring the first test executive step to call a first code module during execution of the test executive sequence; and
configuring the first test executive step to perform one or more hardware switching operations, wherein said configuring the first test executive step to perform the one or more hardware switching operations comprises one or more of:
configuring the first test executive step to perform a hardware switching operation before calling the first code module; and/or
configuring the first test executive step to perform a hardware switching operation after calling the first code module.

27. The method of claim 26,
wherein said configuring the first test executive step to perform the one or more hardware switching operations further comprises:
displaying a user interface useable to specify one or more hardware switching operations;
receiving user input to the user interface specifying the one or more hardware switching operations; and
configuring the first test executive step to perform the specified one or more hardware switching operations in response to the user input to the user interface.

28. The method of claim 26,
wherein said configuring the first test executive step to perform one or more hardware switching operations comprises configuring the first test executive step to perform a connect operation.

29. The method of claim 28,
wherein said configuring the first test executive step to perform the connect operation comprises configuring the first test executive step to perform the connect operation before calling the first code module.

30. The method of claim 26,
wherein said configuring the first test executive step to perform one or more hardware switching operations comprises configuring the first test executive step to perform a disconnect operation.

31. The method of claim 30,
wherein said configuring the first test executive step to perform the disconnect operation comprises configuring the first test executive step to perform the disconnect operation after calling the first code module.

32. The method of claim 26,
wherein said configuring the first test executive step to perform one or more hardware switching operations comprises configuring the first test executive step to perform a connect operation before calling the first code module and configuring the first test executive step to perform a disconnect operation after calling the first code module.

33. A computer-implemented method comprising:
executing a test executive application, wherein the test executive application implements a plurality of step types, wherein the plurality of step types includes a switch step type;
receiving user input to the test executive application to create a test executive sequence, wherein the test executive sequence includes a plurality of test executive steps, wherein the plurality of test executive steps includes a first test executive step, wherein the first test executive step is an instance of the switch step type; and
configuring the first test executive step to perform one or more hardware switching operations.

34. The method of claim 33,
wherein the switch step type provides an interface for configuring step instances of the switch step type to perform a plurality of hardware switching operations.

35. The method of claim 34, further comprising:
executing the test executive sequence;
wherein said executing the test executive sequence comprises executing the first test executive step;
wherein said executing the first test executive step comprises performing the one or more hardware switching operations.

36. The method of claim 35,
wherein said executing the test executive sequence comprises performing one or more tests of a unit under test (UUT).

37. The method of claim 33,
wherein said configuring the first test executive step to perform one or more hardware switching operations comprises configuring the first test executive step to perform one or more of:
causing connections to be made in one or more switch devices;
causing disconnections to be made in one or more switch devices;
determine connectivity between channels in one or more switch devices;
query one or more switch devices for information;
cause one or more switch devices to perform a scanning operation;
perform a wait operation, wherein the wait operation comprises waiting for one or more switches to debounce;
configure one or more switches in one or more switch devices; and
send a software trigger command to one or more switch devices.

38. The method of claim 33, further comprising:
executing a second application, wherein the second application is operable to create switch configuration information;
receiving input to the second application specifying desired switch configuration information; and
storing the specified switch configuration information;
wherein said configuring the first test executive step to perform the one or more hardware switching operations utilizes the switch configuration information.

39. The method of claim 38,
wherein said configuring the first test executive step to perform the one or more hardware switching operations comprises:
displaying a user interface for configuring the first test executive step; and
receiving user input to the user interface to specify the one or more hardware switching operations, wherein said receiving user input to the user interface to specify the one or more hardware switching operations comprises receiving user input specifying at least a portion of the switch configuration information.

40. The method of claim 39,
wherein said receiving input to the second application specifying desired switch configuration information comprises receiving input to the second application specifying one or more pre-configured routes;
wherein said receiving user input to the user interface to specify the one or more hardware switching operations comprises:
receiving user input to specify one or more of a connect operation and/or a disconnect operation; and
receiving user input to specify that the connect operation and/or disconnect operation operate on the one or more pre-configured routes.
